(19) United States
(12) Patent Application Publication
(10) Pub. No.: US 2012/0215657 A1
(43) Pub. Date: Aug. 23, 2012

(54) Vendor Selection for Purchase of Resources

(76) Inventors: David Compton, Ventura, CA (US); Steven Markowitz, Ventura, CA (US); Scott de Rozic, Spokane, WA (US); Mark Evans, Ventura, CA (US)

(21) Appl. No.: 13/461,739

(22) Filed: May 1, 2012

Related U.S. Application Data
(63) Continuation-in-part of application No. 12/955,385, filed on Nov. 29, 2010.
(60) Provisional application No. 61/265,192, filed on Nov. 30, 2009.

(51) Int. Cl. G06Q 30/06

(52) U.S. Cl. 705/26.8

(57) ABSTRACT

A vendor sends, to a host, affiliate links for resources that the vendor is offering for sale and formatting for its on-line order form. The host uses the affiliate links and a vendor selection criterion to select a vendor from which to purchase a customer's desired resource. The host populates, without further customer input, the order form of the selected vendor. The host receives a purchase availability status for the desired resource and, when the desired resource is available, completes the purchase from the selected vendor, without any additional customer input. When the desired resource is unavailable, the host populates an order form of another selected vendor using the respective formatting and completes the purchase without any additional customer input.

### CROSS-REFERENCE TO RELATED APPLICATIONS

This application is a continuation-in-part of, claims priority to, and the benefit of, U.S. application Ser. No. 12/955,385, filed on Nov. 29, 2010, titled “Scheduled Repetitive Search,” which claimed priority and the benefit of U.S. Application Ser. No. 61/265,192, filed on Nov. 30, 2009, titled “Scheduled Repetitive Search,” the entire contents of each of which are incorporated herein by reference.

### BACKGROUND

Customers, such as household consumers and business operators, typically have certain resources (e.g., goods or services) that they purchase. A household consumer may purchase dog food or toilet paper on a routine basis while a business operator may purchase paper or a printer toner on a routine basis. Sometimes it is difficult for the customer to time his next purchase to replenish the resource so that the customer is not left without the resource. For example, if the household consumer runs out of the dog food, the consumer may have to run to a supermarket to purchase another bag of dog food in time to feed the dog. In some instances, the purchase cannot be done at the last minute and the customer is left without the resource when the customer needs it most. Moreover, bulk purchases are difficult to carry and transport, making brick and mortar purchases cumbersome.

Additionally, not only can running out be a problem, but many of these resources can have retail purchase stigmas when bought at traditional supermarkets or drugstores. A recent study has shown that household consumers find tampons to be the number two most embarrassing resource to purchase. The retail purchase stigma may be decreased by conducting an on-line purchase. For example, the household consumer may go on-line to a website of a vendor (e.g., merchant, retailer, or manufacturer), put the tampons in an electronic shopping cart, and use the vendor's electronic check-out process to purchase the item. The vendor may then ship the tampons to the household consumer's address provided during the on-line purchase. Here, however, the household consumer must manually go on-line each time to make another purchase of the tampons.

Accordingly, it would be an advance in the art of commerce to provide solutions for convenient and efficient purchases of resources.

### FIELD

The present invention generally relates to automatically and/or autonomically selecting a vendor that sells a plurality of resources, which a customer desires to purchase, and more particularly to using a vendor criterion to select the vendor from which to purchase all of the plurality of resources and populating, without any customer input, an order form of the selected vendor.

### COPYRIGHT

Contained herein are materials subject to copyright protection. The copyright owner has no objection to the facsimile reproduction of the patent disclosure by any person as it appears in the Patent and Trademark Office patent files or records, but otherwise reserves all rights to the copyright whatsoever.

### SUMMARY

In certain embodiments, an article of manufacture includes a non-transitory computer readable medium, vendor selection criterion encoded therein, and computer readable program code encoded therein, to select a vendor from which to purchase one or more resources. A formatting of an on-line order form and one or more affiliate links for resources that vendors are selling are received and encoded in the non-transitory computer readable medium. A description of one or more desired resources that a customer desires to purchase is received. The affiliate links are used along with the predetermined vendor selection criterion to select one or more of the vendors from which to purchase one or more of the desired resources. Corresponding order forms are populated, without any additional customer input, using the received formatting of the respective order form. A purchase availability status of one or more of the desired resources is received. When the purchase availability status indicates that one or more of the desired resources is available, the purchase of the one or more desired resources from the first selected vendor is completing, without any additional customer input.

In certain embodiments, a method for selecting a vendor from which to purchase a plurality of resources desired by a customer includes receiving from a plurality of vendors, formatting of a respective on-line order form and one or more affiliate links for resources that the corresponding vendor is offering for sale. The formatting and affiliate links are encoded in a non-transitory computer readable medium. Payment information of a customer and a delivery address are received. The customer information is stored in the non-transitory computer readable medium. A vendor selection criterion and a description of a plurality of desired resources that the customer desires to purchase and have delivered to the delivery address is received. The vendor selection criterion is used to select a vendor from which to purchase all of the desired resources. The formatting is used to populate the respective order form of the selected vendor, without any additional customer input, for purchase and delivery of the all of the desired resources to the delivery address. A purchase availability status is received and when the purchase availability status indicates that all of the desired resources are available, the purchase of all of the desired resources from the selected said vendor is completed, without any additional customer input.

In certain embodiments, a computer program product is useable with a computing device comprising a programmable processor to select a vendor from which to purchase resources desired by a customer. The computer readable program code causes the programmable processor to receive and encode in a non-transitory computer readable medium, a formatting of an on-line order form and one or more affiliate links for resources that the vendor is offering for sale. The computer readable program code causes the programmable processor to receive a description of one or more desired resources that a customer desires to purchase. The computer readable program code causes the programmable processor to use the affiliate links and a predetermined vendor selection criterion to select one or more vendors from which to purchase one or more of the desired resources. The computer readable program code causes the programmable processor to populate, without any additional customer input, a corresponding order form of a first selected vendor using the formatting of the respective order form. The computer readable program code causes the programmable processor to receive, from a first selected vendor, a purchase availability status of one or more of the desired resources. The computer readable program code causes the programmable processor to, when the purchase availability status indicates that one or more of the desired said resources is available, complete, without any additional customer input, a purchase of one or more of the desired resources from the first selected vendor.

### BRIEF DESCRIPTION OF THE DRAWINGS

Implementations of the invention will become more apparent from the detailed description set forth below when taken in conjunction with the drawings, in which like elements bear like reference numerals.

FIG. 1 depicts a block diagram illustrating an exemplary system in which scheduled repetitive searches for a resource may be conducted;

FIG. 2 illustrates a flow chart of an exemplary method for scheduled repetitive searches for a resource;

FIG. 3 illustrates a flow chart continuing the method of FIG. 2;

FIG. 4 illustrates a flow chart of an exemplary method for scheduled repetitive, autonomic searches for a resource;

FIG. 5 illustrates User Interfaces rendered on a customer computing device in the system depicted in FIG. 1;

FIG. 6 illustrates an exemplary timeline for the scheduled repetitive searches for a resource;

FIG. 7 illustrates a flow chart of another exemplary method for scheduled repetitive searches for a resource;

FIG. 8 illustrates a flow chart continuing the method of FIG. 7;

FIG. 9 illustrates a flow chart of an exemplary method for scheduled repetitive, autonomic searches for a plurality of resources;

FIG. 10 illustrates a User Interface rendered on a customer computing device in the system depicted in FIG. 1;

FIG. 11 illustrates another User Interface rendered on a customer computing device in the system depicted in FIG. 1;

FIG. 12 illustrates yet another User Interface rendered on a customer computing device in the system depicted in FIG. 1;

FIG. 13 illustrates a flow chart of exemplary method for selecting a vendor that sells a plurality of resources, which a customer desires to purchase and have delivered;

FIGS. 14-19 each illustrate a User Interface rendered on one or more computing devices in the system depicted in FIG. 1;

FIGS. 20-22 illustrate automatic/autonomic population of a vendor's order form; and

FIGS. 23-31 each illustrate a User Interface rendered on one or more computing device in the system depicted in FIG. 1.

### DETAILED DESCRIPTION

Implementations are described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” “certain embodiments,” and similar language throughout this specification may, but do not necessarily, all refer to the same embodiment.

The described features, structures, or characteristics may be combined in any suitable manner in one or more embodiments. In the following description, numerous specific details are recited to provide a thorough understanding of embodiments described herein. One skilled in the relevant art will recognize, however, that the implementations described herein may be practiced without one or more of the specific details, or with other methods, components, materials, and so forth. In other instances, well-known structures, materials, or operations are not shown or described in detail to avoid obscuring aspects of the implementations described.

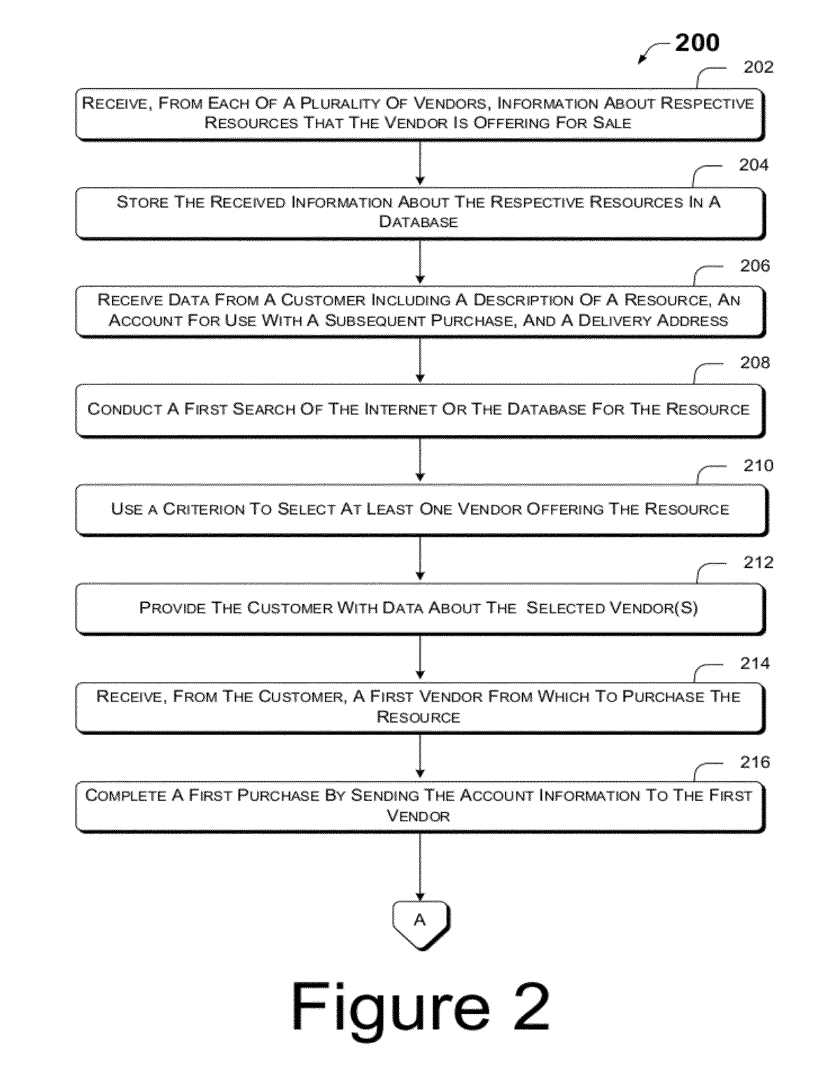

The schematic flow chart diagrams included are generally set forth as a logical flow-chart diagram (e.g., FIGS. 2, 3, 4, 7, 8, 9, and 13). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIGS. 2, 3, 4, 7, 8, 9, and 13). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

A customer uses a customer computing device to set up an on-line profile with a host computing device. The on-line profile includes data that specifies resources that the customer is interested in purchasing on a one-time basis, ad hoc basis, and/or on a repeated schedule. For example, the on-line profile includes data about: the resource (e.g., brand name, a description of the resource, or a desired quantity); a specified delivery schedule (e.g., every week, every 23 days, every 2 years) for repeat deliveries; a social authorization via a social network such as Facebook®, Google+®, Twitter® or future networks; a payment account that can be used to make the future purchases; a billing address; a mobile or landline phone number; numerous personal preferences such as vision and prescription information brand or savings preferences for purchased resources, or vendors, delivery preferences; additional third-party services and integrations such as vendor loyalty programs, complementary productivity tools and incentive programs; demographic information; and/or a delivery address for delivery of the purchased resources.

In certain embodiments, one or more customers that choose to integrate their existing loyalty cards and programs do so by creating a vendor profile that includes a vendor's name, and/or the customer's loyalty identifier (e.g., loyalty card number) with the vendor . . . etc. In certain embodiments, the customer changes the email address and password of the customer stored by the vendor to an email address and password associated with the customer and stored in the a non-transitory computer readable medium 111. Optionally, new loyalty accounts are created for the customer upon a purchase from that vendor (e.g., the first purchase from the vendor).

The host computing device then conducts searches, on the Internet or within a database. For example, the host computing device conducts searches on the Internet on a preselected chronological schedule for repeated scheduled purchases, or in real-time, while the customer is using the customer computing device, for an on-demand purchase.

The host computing device selects one or more vendors that are capable of selling the resource to the customer using a vendor selection criterion (e.g., “lowest price”). In certain embodiments, the host computing device queries the customer to confirm the purchase, to determine whether to place the order, delay the order, expedite the order, or to forgo the order. For the resources that are to be purchased on a repeated schedule, the host computing device automatically and/or autonomically conducts scheduled repetitive searches for the resources that may be subsequently purchased from any of a plurality of vendors. The resources for repeated schedule purchases have a predictable depletion period (e.g., dog food or toner) or a predictable period for providing the resource (e.g., carpet cleaning).

In certain embodiments, the resource is purchased from the vendor that is offering the resource for the lowest price (e.g., that may or may not include the shipping costs, handling costs, or taxes). Consequently, the host computing device is configured to select a vendor to purchase one or more resources, and/or calculate and coordinate: the scheduled repetitive searches, the specified delivery schedule, and the vendor's estimated shipping duration such that the resources are replenished, for example, without the customer running out of the resource.

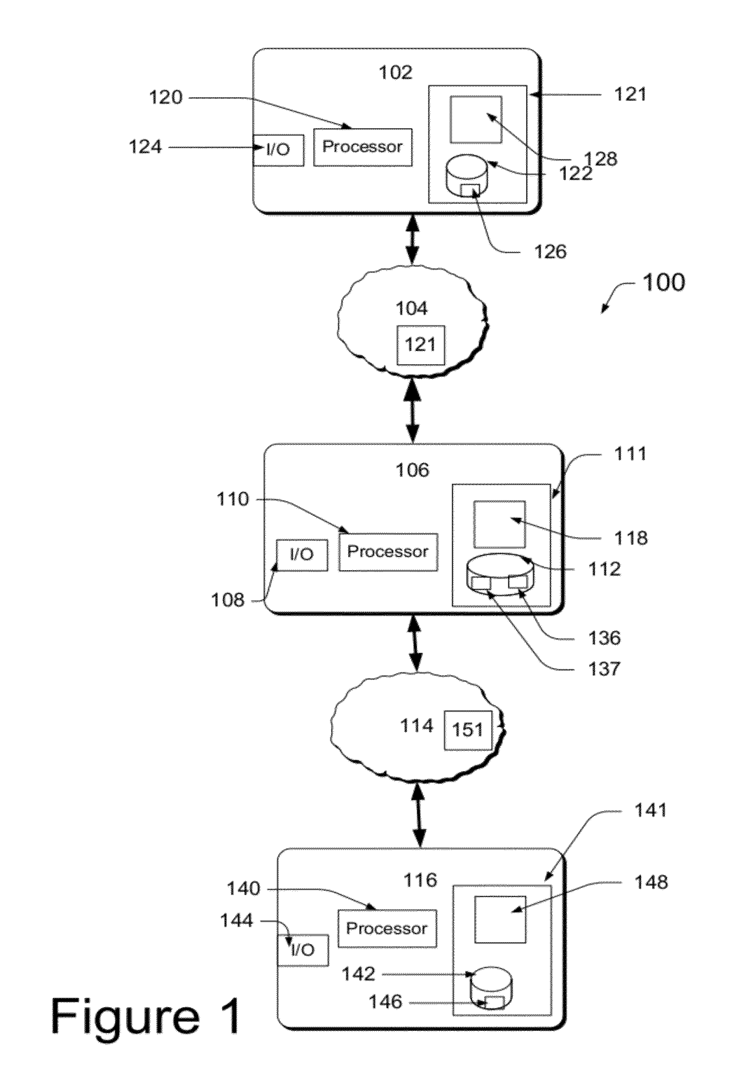

Referring to FIG. 1, a block diagram illustrates an exemplary system 100 for selecting a vendor from which to purchase one or more resources desired by a customer. The system 100 depicts a computing device 106 that is communicatively connected to a computing device 116 through a first network 114, and to a computing device 102 through a second network 104. In certain embodiments, the computing device 106 represents one or more computing devices that are owned and/or operated by a host (also referred to as, “host computing device 106”); the computing device 116 represents one or more computing devices that are owned and/or operated by a customer (also referred to as, “customer computing device 116”); and the computing device 102 represents one or more computing devices that are owned and/or operated by a vendor (also referred to as, “vendor computing device 102”).

Although, for the sake of clarity, one host computing device 106, one customer computing device 116, and one vendor computing device 102 are shown in FIG. 1, it will be apparent that any number of entities and corresponding devices can be part of the system 100, and further that, while two networks 104 and 114 are shown, any number of networks (e.g., less or more than depicted in FIG. 1) could be provided in the system 100. For example, in certain embodiments, the communication fabric 104 and the communication fabric 114 are the same communication fabric.

In certain embodiments, the vendor computing device 102, the host computing device 106, and the customer computing device 116 are each an article of manufacture that is configured to execute an algorithm (e.g., a computer readable program code or software) to receive data, transmit data, store data, or perform methods. Examples of a computing device includes a special purpose computer having one or more processors (e.g., a Central Processing Unit, a Graphical Processing Unit, or a microprocessor) such as: a server, a mainframe computer, a mobile telephone, a personal digital assistant, a personal computer, a laptop, a tablet, other mobile device, a set-top box, an MP3 player, an email enabled device, a web enabled device.

By way of illustration and not limitation, FIG. 1 illustrates the computing device 102, the computing device 106, and the computing device 116 as each including: a processor (120, 110, and 140, respectively); a non-transitory computer readable medium (121, 111, and 141, respectively) having a series of instructions, such as computer readable program steps encoded therein; and an input/output means (124, 108, and 144, respectively) such as a keyboard, a mouse, a stylus, touch screen, a camera, a scanner, or a printer. The non-transitory computer readable mediums 121, 111, and 141 each include corresponding computer readable program codes (128, 118, and 148, respectively) and data repositories (122, 112, and 142, respectively). The processors 120, 110, and 140 access corresponding computer readable program codes (128, 118, and 148, respectively), encoded on the corresponding non-transitory computer readable mediums (121, 111, and 141, respectively), and executes one or more corresponding instructions (126, 136, and 146, respectively). In certain embodiments, the corresponding non-transitory computer readable mediums (121, 111, and 141, respectively) each comprises one or more hard disk drives, tape cartridge libraries, optical disks, or any suitable volatile or nonvolatile storage medium, storing one or more databases, or the components thereof, in a single location or in multiple locations, or as an array such as a Direct Access Storage Device (DASD), redundant array of independent disks (RAID), virtualization device, . . . etc.

In certain embodiments, the processors 120 and 140 each access corresponding Application Program Interfaces (APIs) encoded on the corresponding non-transitory computer readable mediums (121 and 141, respectively), and executes instructions (e.g., 126 and 146, respectively) to electronically communicate with the computing device 106. Similarly, the processor 110 accesses the computer readable program code 136, encoded on the non-transitory computer readable medium 111, and executes an instruction to electronically communicate with the computing device 102 via the communication fabric 104 and/or electronically communicate with the computing device 116 via the communication fabric 114.

In certain embodiments the data stored in the data repository 112 of the host computing device 106 includes information received from the customer computing device 116 or the vendor computing device 102, or their respective past usage of the system 100. A log 137 is maintained of the information or data about the communicated information (e.g., date and time of transmission, frequency of transmission . . . etc.) with the computing device 102 and/or the computing device 116. In certain embodiments, Applicants' method reviews log 137 and generates purchasing suggestions based upon prior purchases. In certain embodiments, this review and purchasing suggestion generation is performed by a processor 110 disposed in host computing device 106. In certain embodiments, Applicants' method allows a customer's remote computing device, such as computing device 116, to access that customer's log 137 and/or that customer's data in data repository 112. In certain embodiments, Applicants' method installs a data mining algorithm on customer computing device 116. In these embodiments, the customer computing device 116 utilizes Applicants' data mining algorithm in combination with the customer's log 137 and/or customer data encoded in a non-transitory computer readable medium 111 to review log 137 and generate purchasing suggestions based upon prior purchases. This distributed computing embodiment optimizes the review process by distributing the data mining operations to a plurality of individual customer computing devices while maintaining control of the customer log 137 and a non-transitory computer readable medium 111.

For example, the host computing device 106 mines or analyzes a purchase history of a particular customer that is stored in the a non-transitory computer readable medium 111 to determine that a particular customer has accessed the system 100, to purchase cat food on a repeated basis. Here, the host computing device 106 executes algorithms to determine a probability that the particular customer likely has a cat and will likely also desire to purchase cat litter.

In certain embodiments, one or more of the data repositories 122, 112, and 142 are structured by a database model, such as a relational model, a hierarchical model, a network model, an entity-relationship model, an object-oriented model, or a combination thereof. For example, in certain embodiments, the data repository 112 is structured in a relational model and stores a plurality of customer described resources as attributes in a matrix for an online shopping list.

In certain embodiments, the computing devices 102, 106, or 116 include wired and wireless communication devices which can employ various communication protocols including near field (e.g., “Blue Tooth” and Wifi) and far field communication capabilities (e.g., satellite communication or communication to cell sites of a cellular network) that support any number of services such as: Short Message Service (SMS) for text messaging, Multimedia Messaging Service (MMS) for transfer of photographs and videos, bar codes, QR codes, electronic mail (email) access, or Global Positioning System (GPS) service, for example.

As illustrated in FIG. 1, the communication fabrics 104 and 114 each comprise one or more switches 121 and 151, respectively. In certain embodiments, at least one of the communication fabrics 104 and 114 or other networks described in this application, is a public or private network, and includes any of a variety of one or more suitable means for exchanging data, such as: the Internet, an intranet, an extranet, a storage area network (SAN), a wide area network (WAN), a local area network (LAN), a virtual private network, a satellite communications network, an Automatic Teller Machine (ATM) network, an interactive television network, or any combination of the foregoing. In certain embodiments, at least one of the communication fabrics 104 and 114 contains either or both wired or wireless connections for the transmission of signals including electrical connections, magnetic connections, or a combination thereof. Examples of these types of connections are known in the art and include: radio frequency connections, optical connections, telephone links, a Digital Subscriber Line, or a cable link. The networks utilize any of a variety of communication protocols, such as Transmission Control Protocol/Internet Protocol (TCP/IP), for example.

By way of example, the host computing device 106 is shown as a server, including a processor 110, a non-transitory computer readable medium 111, an input/output means 108 (e.g., a keyboard, a mouse, a stylus and touch screen, or a printer) or, and a data repository 112. The processor 110 accesses executable code stored on the non-transitory computer readable medium 111, and executes one or more instructions 118 to, for example, electronically communicate with the customer computing device 116 or the vendor computing device 102.

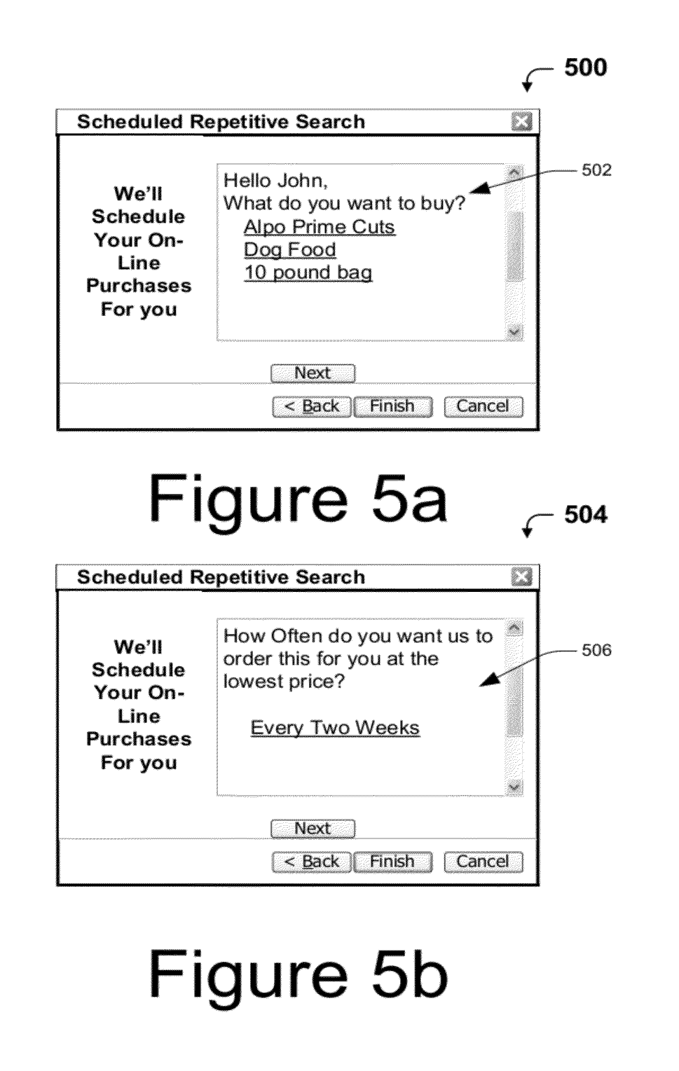

Referring to FIGS. 2, 3, 4, 7, 8, and 9, flowcharts summarize exemplary methods 200, 300, 400, 700, 800, and 900, respectively, for conducting scheduled repetitive searches for resources for subsequent respective purchases. FIGS. 5, 10, 11, and 12 depict screen shots of exemplary User Interfaces that facilitate the execution of the steps of the methods 200, 300, 400, 700, 800, and 900.

At a step 202 of method 200 in FIG. 2, the host computing device 106 optionally receives from each of a plurality of vendors, information about respective resources that the corresponding vendor is offering for sale. The information includes, for example, a description of each resource offered for sale, such as a Stock Keeping Unit (SKU) number, Universal Product Code (UPC), a brand name, a manufacturer name, a make or model of the resource, a quality of the resource (e.g., “made in America,” “green product,” “locally grown,” or other descriptor), a quantity of units within a package of the resource (e.g., 10 pounds, 6 cans), reviews about a quality of the resource (e.g. top rated cereal), a shipping cost for the resource, a shipping cost for a group of resources, or an estimated shipping duration (e.g. 5 business days for ground transportation). At a step 204, the host computing device 106 optionally stores the received information about the respective resources at the non-transitory computer medium 111.

At a step 206, the host computing device 106 receives data from a customer. For example, the customer uses the customer computing device 116 to connect to the Internet and access an interactive website associated with the host computing device 106. The customer creates a customer profile by entering data about the customer into fields rendered upon the customer computing device 116. This includes: for example, a name of the customer; an account identifier of the customer usable to make a future purchase (e.g., checking account number, a credit account number, a charge card account number, an electronic wire transfer account number); a billing address for the customer (e.g. residential address); a delivery address for the customer (e.g. a location to which resources are to be delivered); a description of one or more resources the customer is interested in or desires to purchase, such as a data identifying each resource (e.g., a brand, a manufacturer name, a SKU number, or a UPC); a quantity of the one or more resources the customer wishes to purchase; or a specified delivery schedule. To illustrate, the customer logs on to the interactive website and, as depicted by the User Interface 500 in FIG. 5, identifies the resource at 502 as “Alpo Prime Cuts Dog Food, 10 pound bag.” In certain embodiments, the interactive website provides a listing of resources available for purchase in each of a plurality of categories for ease of selection.

In certain embodiments, the customer specifies a delivery schedule for recurring delivery of one or more resources. As illustrated in User Interface 500 and 504 of FIGS. 5a and 5b, respectively, the customer enters a duration of time that the customer would like to lapse between the delivery of the first Alpo® Prime Cuts Dog Food and a subsequent delivery of the Alpo® Prime Cuts Dog Food. Here, the customer has indicated at element 506 that the customer would like a two-week window between deliveries. Other windows of time are also applicable such as one month, 23 days, one year and the like.

In certain embodiments, the delivery schedule for recurring delivery of one or more resources is a function of past payment transactions or purchases by the customer. For example, the host computing device 106 analyzes or mines data associated with the customer, such as past purchases and timing of the corresponding purchases stored in the data repository 112. The host computing device 106 then runs a prediction algorithm to determine if, based on the past purchases, the customer is likely to want to purchase certain resources. To illustrate, if the data stored in the non-transitory computer readable medium 111 indicates that a customer has bought meat every two weeks for the past 3 months, the prediction algorithm will indicate that the customer is likely to want to purchase meat again at a delivery schedule of two weeks.

In certain embodiments, the customer desires to purchase and have one or more resources delivered to the delivery address, on a one-off or on-demand basis. For example, the customer selects one or more resources for purchase without indicating a repetitive delivery schedule for the one or more resources. Here, if the customer wishes to have the resource delivered a second time, the customer subsequently selects the resource again for a second on-demand purchase. In this manner, the customer is not bound by a delivery schedule and has the option to make a single purchase or subsequent purchases at the whim of the customer, without a predetermined schedule. For example, the customer selects to purchase and have delivered, on a one-time basis, a package of toilet paper and does not indicate a repetitive schedule for delivery (e.g., every two weeks). Consequently, the package of toilet paper is to be delivered on a nonrepetitive delivery schedule, such as a single time.

Referring back to method 200 of FIG. 2, at a step 208, the host computing device 106 conducts an electronic search for vendors selling the resource described in the step 206. For example, the host computing device 106 conducts a search for vendors offering to sell “Alpo Prime Cuts Dog Food” using an Internet search engine. Here, the host computing device 106 matches data identifying the resource with a description of resources offered for sale by a plurality of vendors. Alternatively or in combination, the host computing device 106 conducts a search of the a non-transitory computer readable medium 111 to find the vendor(s) offering to sell one or more resources described in the step 206.

At a step 210, the host computing device 106 uses a vendor selection criterion to select at least one vendor offering the one or more resources for sale. The vendor selection criterion is, for example, the vendor having the lowest price for the resources (e.g., cost of the resource or the cost of the resource plus fees for shipping or handling of the resource in association with a purchase of the resource). Alternatively, or in combination, the vendor selection criterion is the vendor offering one or more resources that: are made in a specified country (e.g., “made in America”); were grown within geographic proximity to the delivery address of the customer; or have the best resource review, for example. Other vendor selection criteria are also contemplated.

In certain embodiments, the vendor selection criterion is predetermined, such as by the host, the vendor, the customer, or a combination thereof. For example, the host predetermines that the vendor selection criterion is the vendor selling and delivering one or more resources for the lowest cost. In another embodiment, the vendor selection criterion is predetermined by the customer and/or the vendor. For example, the customer wishes to purchase resources that have good customer reviews and/or are made in America. Here, the vendor selection criterion reflects characteristic of the resource that the customer priorities for purchase, or combinations thereof. In certain embodiments, if the vendor selection criterion includes more than one characteristic of the desired resource, the characteristics that take higher precedence than other characteristics is predetermined, such as by the host, the vendor, the customer, or a combination thereof. In certain embodiments, if the search criterion includes more than one ranked characteristic then the vendor is selected by formulaic rules that substantially effectuate the preferred ranking of the customer, such as through a weighting system. To illustrate, if the customer ranks “made in America” higher than “lowest cost,” then the formulaic rule weighs vendors with resources that are “made in America” higher than vendors that have the “lowest cost” for the resource.

At a step 212, the host computing device 106 provides the customer with data about the selected vendor(s) selected in the step 210. For example, an interactive website is rendered upon the customer computing device 116 showing a ranked listing of the vendors based on the vendor selection criterion such as “The Alpo Dog Food may be purchased from each of the following: Walgreens $50; Wal-Mart $45; or Safeway $20.” In certain embodiments, a selection of the vendors is displayed to the customer via a User Interface.

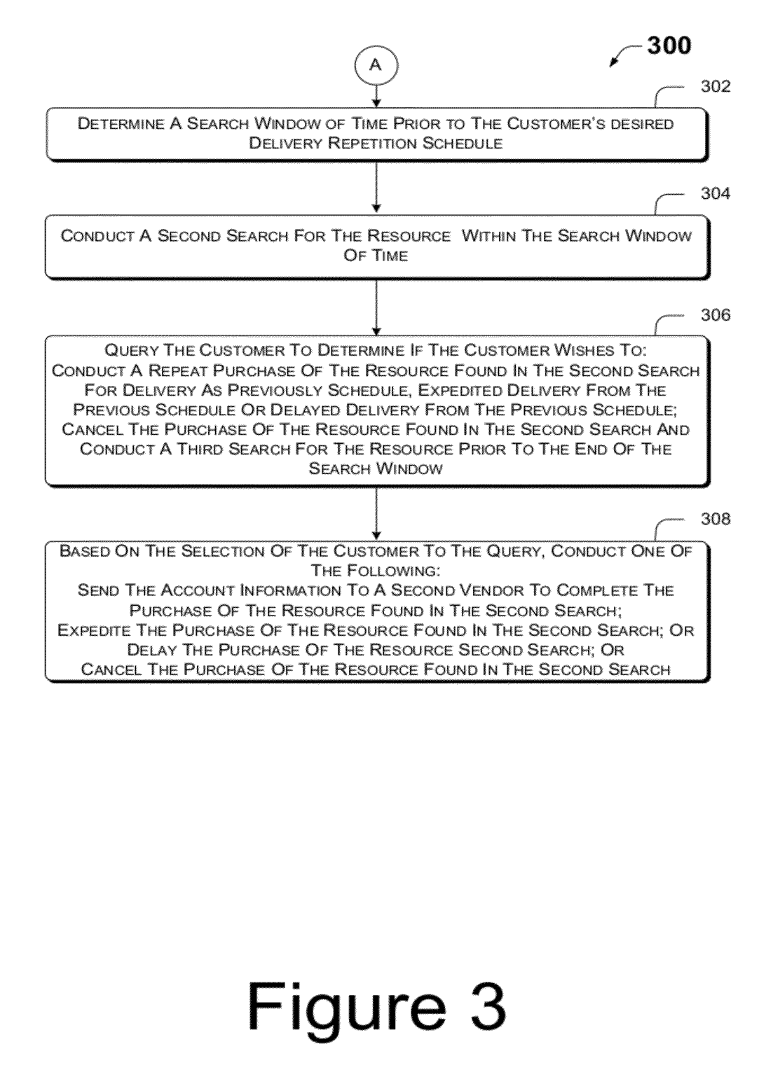

At a step 214, the host computing device 106 receives from the customer computing device 116, data about a first vendor from which the customer has selected to purchase the one or more resources. For example, the customer selects “Safeway” from the above vendor list. At a step 216, the host computing device 106 completes a first purchase of the resource by sending the payment account information of the customer to the first vendor selected at the step 214. Here, method 200 moves from step 216 to step 302 via the cross reference “A” in FIG. 2 to FIG. 3.

Referring to FIG. 3, at the step 302, the host computing device 106 calculates a search window of time matching the customer's specified delivery schedule. For example, if the customer indicated at the step 206 that the customer would like the time lapse between the first and second delivery of the resource to be 2 weeks, then the search window of time is one week prior to the second delivery date. Here, the search is conducted one week prior to the second delivery date to give time, for example, for shipping of the one or more resources.

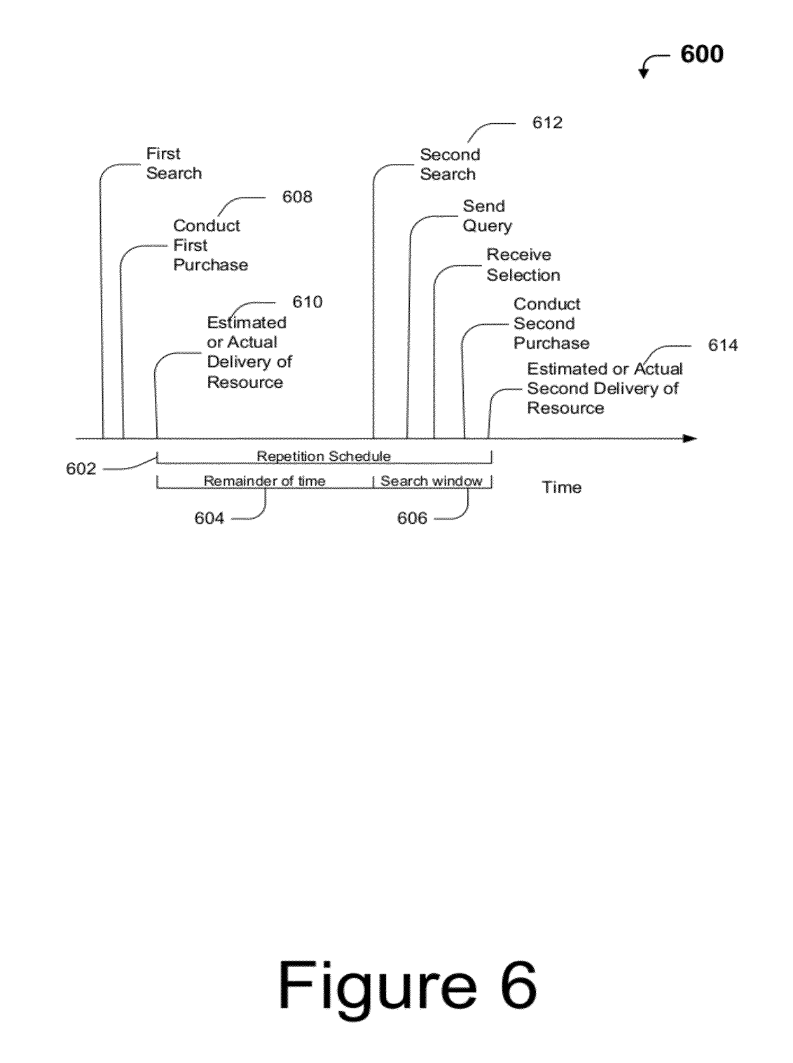

FIG. 6 depicts a chronology of the searches and respective deliveries of the one or more resources, depicted in a timeline. A timeline 600 illustrates a period of time that represents the customer's specified delivery schedule 602. Stated another way, the period of time 602 is an amount of time between two consecutive deliveries, each bought from respective vendors. The period of time 604 is a time period between an estimated or actual first delivery of the resource and a subsequent search for a vendor selling the resource for a second purchase. A search window 606 depicts a duration of time prior to an estimated second delivery. Here, the host computing device 106 automatically (e.g., with minimal human intervention) and/or autonomically (e.g., in a self-regulating manner) conducts a prescheduled search for a vendor selling the resource during the search window 606. To illustrate, if the customer's specified delivery schedule is every 30 days, for example, the period of time 604 may be 20 days and the search window 606 is 10 days. Therefore, here, the search or searches for the vendors selling the resource may be conducted anytime during the 10 days prior to the estimated or actual second delivery of the resource 614.

In certain embodiments, the host computing device 106 calculates a date to conduct a second search 612 for vendors selling the research based on the preselected search window 606, a date of the first purchase 608, an estimated or actual first delivery of the resource 610, and the customer's specified delivery schedule 602. To illustrate, a customer requests monthly delivery of a resource (step 206). The host computing device 106 selects a first vendor from which to buy the resource (step 210) and conducts a first purchase 608 of the resource (step 216). For example, if the first purchase 608 date is Jun. 1, 2009, the host computing device 106 searches the a non-transitory computer readable medium 111 to determine the first vendor's estimated shipping duration, such as 5 days from the date of the first purchase 608. Therefore, a first estimated delivery of the resource 610 is estimated to occur on Jun. 5, 2009, in this example.

Alternatively, or in combination, the host computing device 106 receives data about an actual delivery date. For example, the host computing device 106 receives shipping information from the shipper shipping the one or more resources purchased from the first vendor (or the first vendor itself), such as a tracking number for the shipment of the one or more resources purchased from the first vendor. The host computing device 106 uses the tracking number to check and confirm the actual shipping date of the one or more resources purchased from the first vendor. Alternatively, or in combination, the first vendor transmits a delivery confirmation to the host including the actual date of delivery of the one or more resources purchased from the first vendor. In the above example, the first vendor sends a confirmation to the host computing device 106 that the resource was delivered to the customer's address on Jun. 5, 2009.

Given that the customer's specified delivery schedule 602 is every 30 days in the above example, the host computing device 106 determines that an estimated second delivery of the resource 614 should be on Jul. 5, 2009 (e.g., 30 days from Jun. 5, 2009). Assuming a 10 day preselected search window 506, the host computing device 106 schedules to automatically and/or autonomically conduct the second search 612 between Jun. 25, 2009 and Jul. 5, 2009. In another implementation the preselected search window 606 has an upper and a lower limit. For example, if the search window 606 is a period of time between 10 to 5 days prior to the estimated second delivery of the resource 514, the search is done in time to accommodate a five day delivery period for the second delivery 514.

Referring back to FIG. 6 and method 300 of FIG. 3, at a step 304, the host computing device 106 conducts a second search for the one or more resources within the search window 606. In the above example, the host computing device 106 automatically and/or autonomically conducts a preset search for the resource on Jun. 30, 2009. Here again, the host computing device 106 selects a list of vendors that meet the vendor selection criterion. In certain embodiments, the second list of vendors differs from the first list of selected vendors found in the step 210. Here, the first purchase for the one or more resources is from a first vendor while the second purchase is with a second vendor that is different from the first vendor.

At a step 306, the host computing device 106 sends a transmission to the customer to request customer input, such as sending a transmission to the customer computing device 116 (e.g., a laptop computer used in the step 206) or a second of the customer computing devices 116 of the customer (e.g., a cell phone not used in the step 206). The transmission includes a query to determine if the customer wishes to conduct a repeat purchase of the resource found in the second search 512. For example, the host computing device 106 sends a SMS message or notification to the customer computing device 116 indicating: “Ms. Mary Smith, your next order of Kotex Maxi Pads 24 pack is due to arrive in 5 days. This automatic and/or autonomic purchase will be at the guaranteed lowest current price on the web and requires no action on your part, unless you wish to SPEED UP, SLOW DOWN, SUSPEND, OR CANCEL the delivery.” In certain embodiments, the “SPEED UP” and “SLOW DOWN” “SUSPEND,” or “CANCEL” options of the message are displayed in drop down boxes or entry fields where new delivery dates can be selected if desired. This helps Mary Smith from overstocking resources or feeling locked into future purchases. Mary Smith has the option to conduct the second purchase. Alternatively, Mary Smith has the option to expedite the delivery of the one or more resource (deliver the resource on July 1st rather than July 5th in the above example) or delay the delivery (deliver the resource on July 10th rather than July 5th in the above example). Alternatively, Mary Smith has the option to cancel the delivery of the resource found in the second search and conduct a third search for the resource for delivery at the specified delivery schedule (e.g., Jul. 5, 2009). Alternatively, Mary Smith has the option to cancel the second delivery all together (no delivery of the resource until the subsequent 30 days after Jul. 5, 2009). Other changes to the specified delivery schedule are also contemplated.

In certain embodiments, if the customer's selection affects the vendor selection criterion, a new ranked list is presented to the customer. For example, if the customer selects to expedite the second delivery of the one or more resource, extra shipping and handling costs may come into affect, Here, the host computing device 106 recalculates the costs for each of the vendors in the list of selected vendors. The host computing device 106 then facilitates the rendering of the new list of selected vendors on the customer computing device 116. Alternatively, or in combination, the host computing device 106 repeats the second search of the step 304 for the new delivery date.

In another implementation, the customer receives the query of step 306 prior to the second search (the step 306 occurs before the step 304). Here, the customer selects to cancel the order and the host computing device 106 does not proceed to the step 304 to conduct the second search.

At a step 308, the host computing device 106 conducts the requested action of the customer from step 306. For example, the host computing device 106 completes the second purchase with the second vendor for delivery as denoted by the customer in the step 304. If the delivery is expedited, extra shipping costs may be paid to the vendor for timely delivery. If the delivery is delayed, the order for one or more of the resources is placed at a later date in order for the second delivery to be on the specified delayed date. Alternatively, or in combination, the host computing device 106 transmits to the second vendor the change to the second delivery date.

In another implementation, the host computing device 106 automatically and/or autonomically selects the first vendor or second vendor without providing information about the selected vendors to the customer (e.g., steps 212 or 214 of FIG. 2). For example, the host computing device 106 selects the vendor offering the cheapest price for the resource without further communicating with the customer for additional customer input.

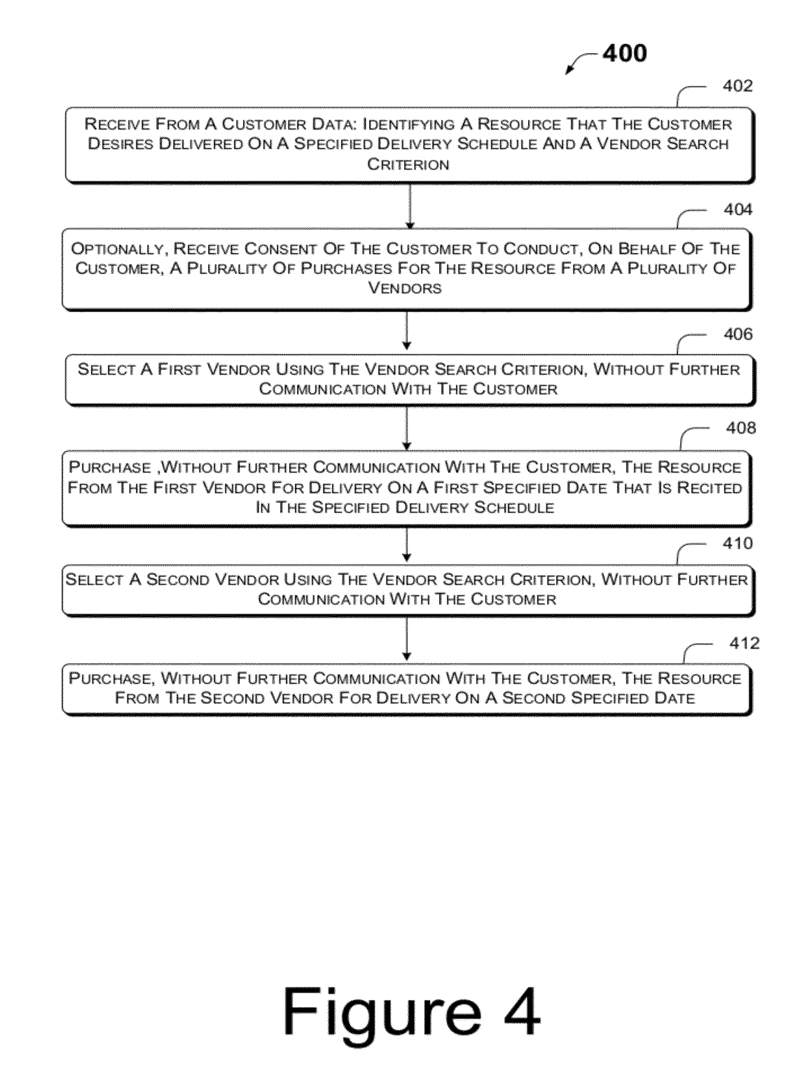

Referring to FIG. 4, a flow chart summarizes an implementation of a method 400 for automatically and/or autonomically conducting scheduled repetitive searches for the one or more resources. At a step 402, data is received from the customer identifying a resource that the customer desires delivered to an address on a specified delivery schedule. For example, the customer identifies “toothpaste” or “COLGATE brand toothpaste” in a search query box of the host accessed via a world wide web User Interface. Further at step 402, a vendor selection criterion is received from the customer. As previously stated, the vendor selection criterion may be “the cheapest price,” “made in America,” “vegan goods,” “recycled material,” another characteristic that reflects the desired resource selection priority of the customer, or combinations thereof. The vendor selection criterion can be preset to a default characteristic, such as “lowest price,” such that the customer need not send a vendor selection criterion in step 402.

In some implementations, as shown at step 404, a consent of the customer is received. The consent allows for a plurality of purchases to occur, on behalf of the customer, for the resource from a plurality of vendors without further customer input, such as consent or authorization of the customer. For example, a consent of the customer can include payment information, such as an identifier of a payment account and a corresponding expiration date, along with approval for the host computing device 106 to submit the payment information to vendors to effectuate a purchase for the resource. As stated previously, the payment information is stored in the a non-transitory computer readable medium 111 and retrieved for the future purchases.

At step 406, a first vendor is selected using the vendor selection criterion without further communication with the customer. Here, the customer is not queried for further information or instruction. Rather, the first vendor is selected autonomically, without further intervention by the customer. Moreover, at step 406, the resource is purchased from the first vendor for delivery on the first specified date, without further communication with the customer.

To illustrate, at step 402, on Apr. 1, 2000, the customer uses the customer computing device 116 to transmit, via the network 114 to the host computing device 106, a request that toothpaste be delivered to a specified residential address every four weeks beginning on Apr. 10, 2000. On Apr. 5, 2000, the host computing device 116 autonomically, without communicating with the customer, searches the Internet for vendors offering to sell the resource. The host computing device 116 uses the vendor selection criterion to select the first vendor that (1) is offering the resource for sale and (2) satisfies the vendor selection criterion. The host computing device 116 effectuates the purchase of the resource from the first vendor by submitting the payment information to the first vendor and accepting the vendor's offer of sale of the resource, on behalf of the customer. The host computing device 116 transmits the payment information to the first vendor, without the host computing device 116 communicating with the customer.

At a subsequent time, a second search is conducted to select a second vendor offering to sell the one or more resources. At step 410 the vendor selection criterion is used to select the second vendor offering to sell the one or more resources. The second vendor may be different or the same as the first vendor. At step 412, the resource is purchased from the second vendor for delivery on a second specified date. As previously stated, the second specified date is determined from the specified delivery schedule. Here, the purchase of the resource from the second vendor occurs without further communication with the customer. In the above example, the host computing device 106 autonomically conducts a second search on the Internet on Apr. 25, 2000 for a second vendor offering to sell the toothpaste. The host computing device 106 autonomically uses the vendor selection criterion to select the second vendor and effectuate the purchase of the toothpaste from the second vendor without querying the customer for data or instruction.

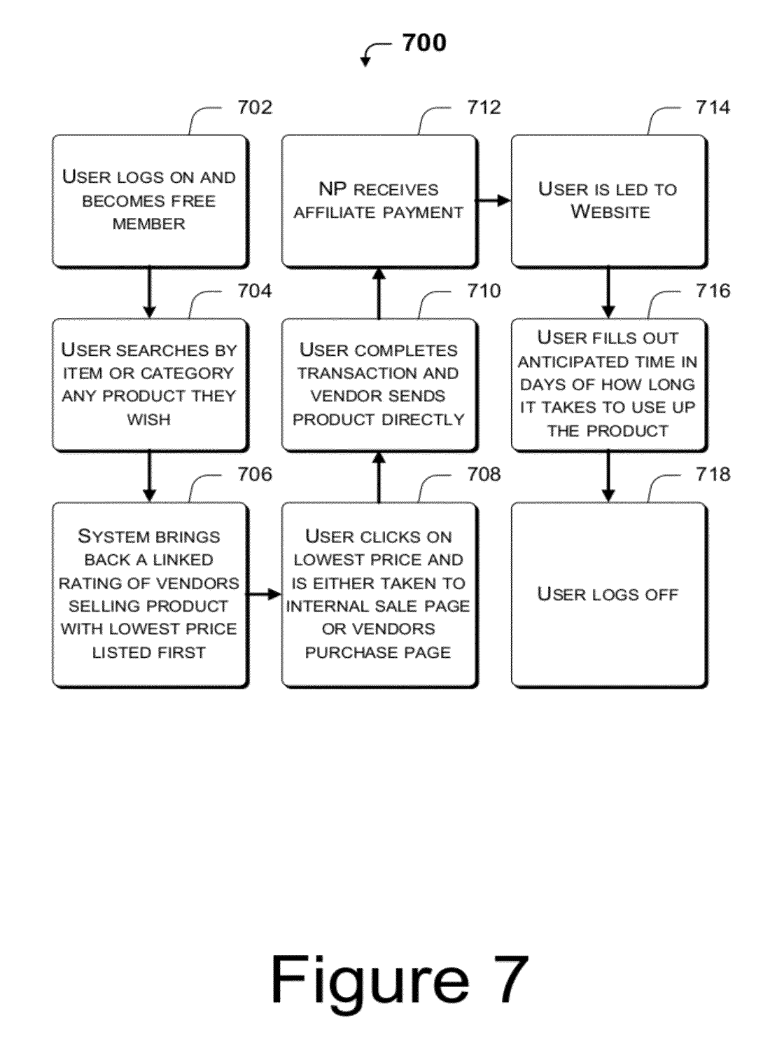

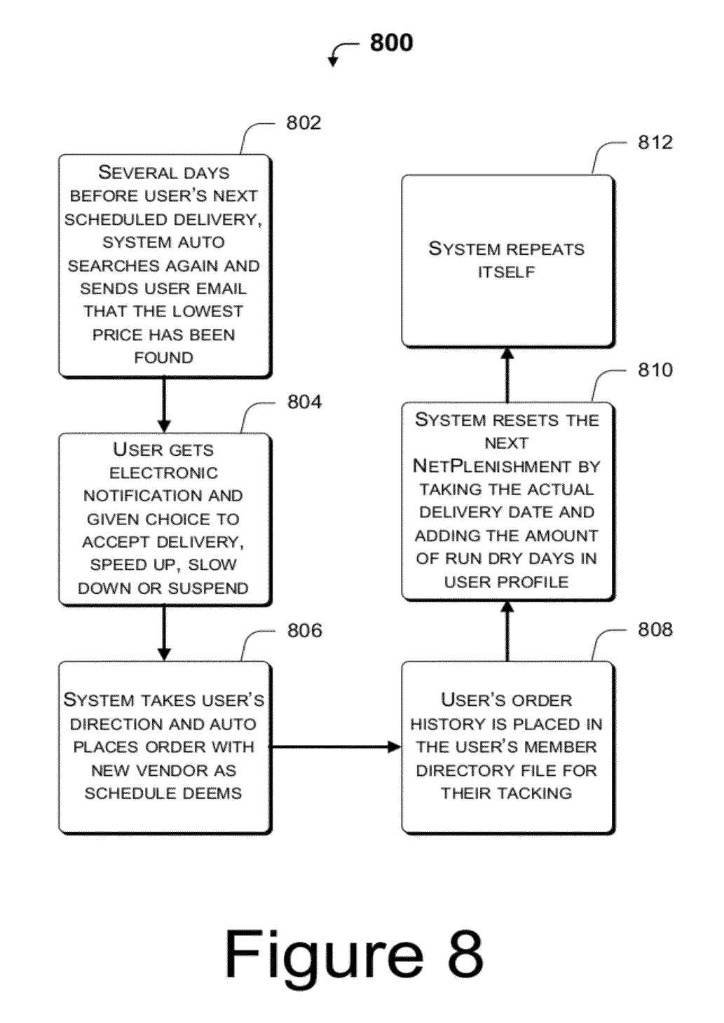

Referring to FIGS. 7 and 8, flow charts summarize another implementation for automatically and/or autonomically conducting scheduled repetitive searches for the resources by the methods 700 and 800, respectively. At a step 702, the user (e.g. customer) logs on and becomes a free member of the system 100. Here, as previously described, the user sends to the host computing device 106 data about the one or more resources that the user wants to repeatedly purchase or data about credit card information for a payment account of the user to use to make subsequent purchases. At a step 704, the user searches for a resource by category or product. At a step 706, the host computing device 106 brings back linked ranking of vendors selling the resource with the lowest price listed first. At a step 708, the user clicks on the lowest price and is taken to either the vendor's purchase webpage or to a webpage associated with the host computing device 106, for example. At a step 710, the user completes the transaction and the vendor sends the resource directly to the address of the customer. At a step 712, the host (“NP”) receives an affiliate payment, such as a fee from each of the vendors listed on the ranked list or a fee from the vendor selected by the user. At a step 714, the user is led to a webpage, such as the vendor's web page or to a web page associated with the host computing device 106. At a step 616, the user fills out anticipated time in days or weeks, for example, of how long it takes to use up the resource. At a step 718, the user logs off of the host's website. The method 700 then continues to step 802 of method 800 of FIG. 8.

Referring to FIG. 8, at a step 802, several days before the user's next scheduled delivery, the host computing device 106 auto searches again and sends the user an electronic notification (e.g., MMS message), that the lowest price has been found. At a step 804, the user gets the electronic notification and responds by selecting to accept delivery, speed up delivery, slow down or suspend the delivery. A default setting may be if the user does not respond to the email sent in the step 802, to automatically and/or autonomically place the order for the resource for delivery to the customer at the specified delivery schedule. At a step 806, the host computing device 106 takes action on the user's selection in step 804 and auto places the order with a new vendor as schedule deems. At a step 808, the user's order history is placed in the user's member directory file for tracking purposes. At a step 810, the system resets the next repeated search by taking the actual delivery date and adding the amount of run dry days (based on the customer's specified delivery schedule 502) in the user profile. At a step 812, the system 200 repeats the steps of searching, alerting the user, and completing the subsequent purchase. In some implementations, the user is not sent an email about the resource and the purchase is completed automatically and/or autonomically.

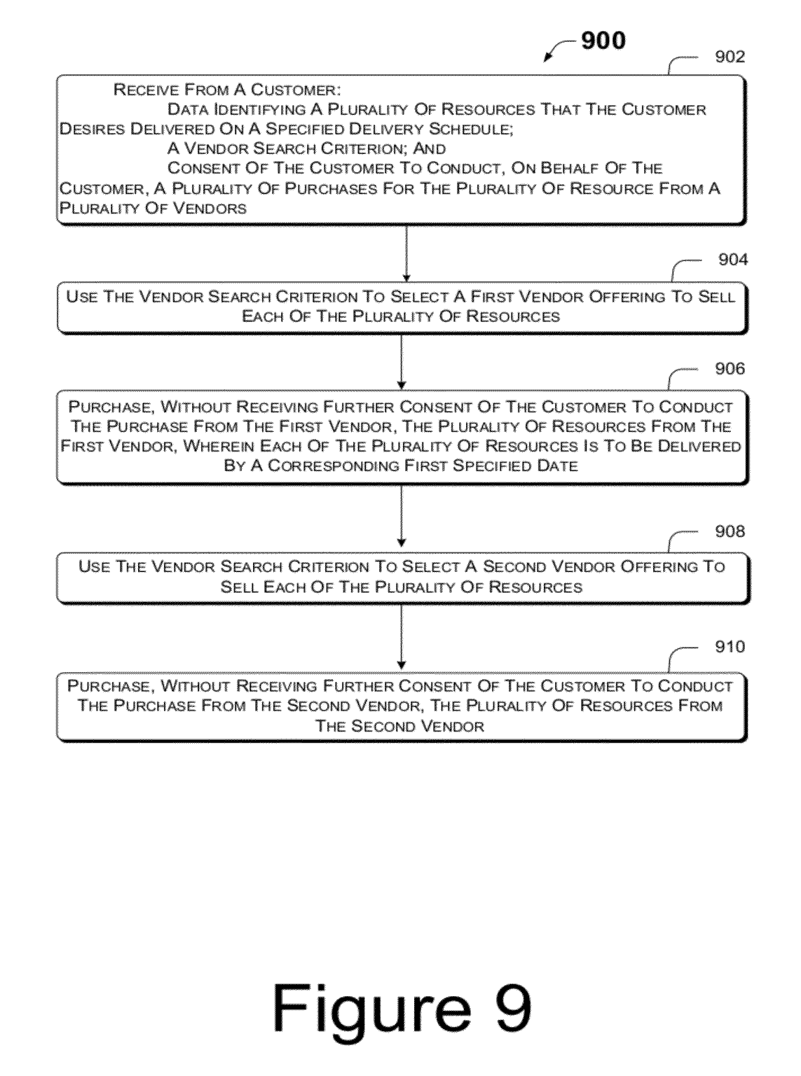

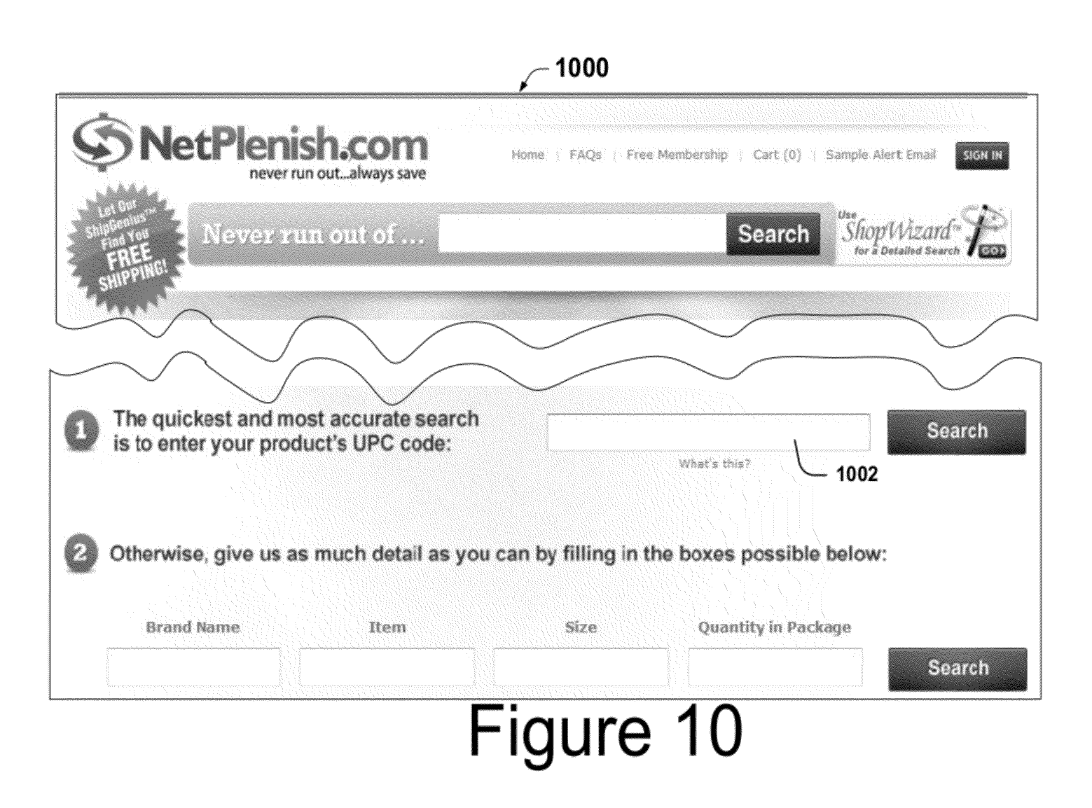

In certain embodiments, the customer selects more than one resource for delivery to a specified address. Referring to FIGS. 9-12, a flow chart in FIG. 9 depicts a method 900 for automatically and/or autonomically conducting scheduled repetitive searches for a plurality of resources and FIGS. 10-12 depict exemplary screen shots of corresponding User Interfaces. At a step 902 of FIG. 9, information is received from a customer. The information includes data identifying a plurality of resources that the customer desires delivered on a specified delivery schedule, a vendor selection criterion, and consent of the customer to conduct, on behalf of the customer, purchases for resources from a plurality of vendors. For example, the customer enters, in succession, each of 3 UPC codes in a search term in a query box 1002 of FIG. 10. The select 3 UPC codes may be, for example, for Disposable Swimpants; (2) Razors; and (3) Multivitamins.

At the step 904, the host computing device 106 uses the vendor selection criterion to select at least one vendor offering to sell all the resources. For example, the host computing device 106 selects the vendor offering the lowest aggregate cost for purchasing and shipping the 3 resources to the address designated by the customer. Here, the aggregate cost for the purchase of all 3 resources from each vendor is, in turn, determined and compared to one another.

The tables below illustrate two exemplary processes for determining the aggregate cost for the purchase of all 3 resources from each of a plurality of vendors. The first three tables show ranking of the vendors if only a single resource was being purchased from each vendor. In this example, the vendors each operate business in a corresponding currency. The currency of the vendors are converted to a single currency for ease of comparison and ranking. Here, the ranking is based on the currency exchange rate of: $US. 62=£1.00 and $US1.02=$CA1.00.

TABLE 1

| | | Price | Rank Based on |
|---|---|---|---|
| | | (with individual | Price of Individual |
| Resource | Vendor | shipping) | Resource |
| Disposable | Vendor 1 | $US10.00 | 1 |
| Swimpants | | | |
| Disposable | Vendor 2 | £7.50 | 3 |
| Swimpants | | | |
| Disposable | Vendor 3 | $CA12.00 | 2 |
| Swimpants | | | |
| Disposable | Vendor 4 | $US15.80 | 4 |
| Swimpants | | | |

TABLE 2

| | | Price | Rank Based on |
|---|---|---|---|
| | | (with individual | Price of Individual |
| Resource | Vendor | shipping) | Resource |
| Razor | Vendor 1 | $US9.80 | 3 |
| Razor | Vendor 2 | £2.30 | 1 |
| Razor | Vendor 3 | $CA8.00 | 2 |
| Razor | Vendor 4 | $US10.80 | 4 |

TABLE 3

| | | Price | Rank Based on |
|---|---|---|---|
| | | (with individual | Price of Individual |
| Resource | Vendor | shipping) | Resource |
| Multivitamin | Vendor 1 | $US10.00 | 4 |
| Multivitamin | Vendor 2 | £1.80 | 1 |
| Multivitamin | Vendor 3 | $CA7.00 | 2 |
| Multivitamin | Vendor 4 | $US8.80 | 3 |

In one implementation, the lowest aggregate cost for purchasing all 3 resources is an arithmetic combination of the individual price.

TABLE 4

| | | Aggregate Cost | Rank Based on The |
|---|---|---|---|
| | | (with individual | Aggregate Price of |
| Resource | Vendor | shipping) | All Resources |
| Disposable | Vendor 1 | $US29.80 | 3 |
| Swimpants | | | |
| Razors | | | |
| Multivitamins | | | |
| Disposable | Vendor 2 | £11.60 | 1 |
| Swimpants | | | |
| Razors | | | |
| Multivitamins | | | |
| Disposable | Vendor 3 | $CA27.00 | 2 |
| Swimpants | | | |
| Razors | | | |
| Multivitamins | | | |
| Disposable | Vendor 4 | $US35.40 | 4 |
| Swimpants | | | |
| Razors | | | |
| Multivitamins | | | |

In the above example in Table 4, the host computing device 106 selects Vendor 2 because Vendor 2 offers the lowest aggregate cost for the purchase of all 3 recourses (£11.60).

In another implementation the aggregate cost includes the individual price for each of the three resources less any savings that may apply for purchasing all 3 resources from the corresponding vendor. For example, a savings may apply for: shipped all three resources in one shipment (“bulk shipping discount”) instead of having each resource individually delivered; the vendor may offer a discount for bulk purchases whether or not the resources are individually delivered; a manufacturer may offer a rebate for purchasing multiple resources together that have a similar brand; or other applicable discounts. The following table illustrates aggregate costs based on individual prices of the resources less savings due to bulk shipment.

| | | Aggregate Cost | |
|---|---|---|---|
| | | (with a single | Rank Based on The |
| | | shipping for all three | Aggregate Price of |
| Resource | Vendor | resources) | All Resources |
| Disposable | Vendor 1 | $US17.80 | 2 |
| Swimpants | | | |
| Razors | | | |
| Multivitamins | | | |
| Disposable | Vendor 2 | £11.60 | 4 |
| Swimpants | | | |
| Razors | | | |
| Multivitamins | | | |
| Disposable | Vendor 3 | $CA19.00 | 3 |
| Swimpants | | | |
| Razors | | | |
| Multivitamins | | | |
| Disposable | Vendor 4 | $US16.00 | 1 |
| Swimpants | | | |
| Razors | | | |
| Multivitamins | | | |

The application of the savings based on shipping all three resources together results in a different cost than the aggregate cost that includes individual shipping. Here, the host computing device 106 would select Vendor 4 because Vendor 4 offers the lowest aggregate cost ($US16.00) for the purchase of all 3 recourses.

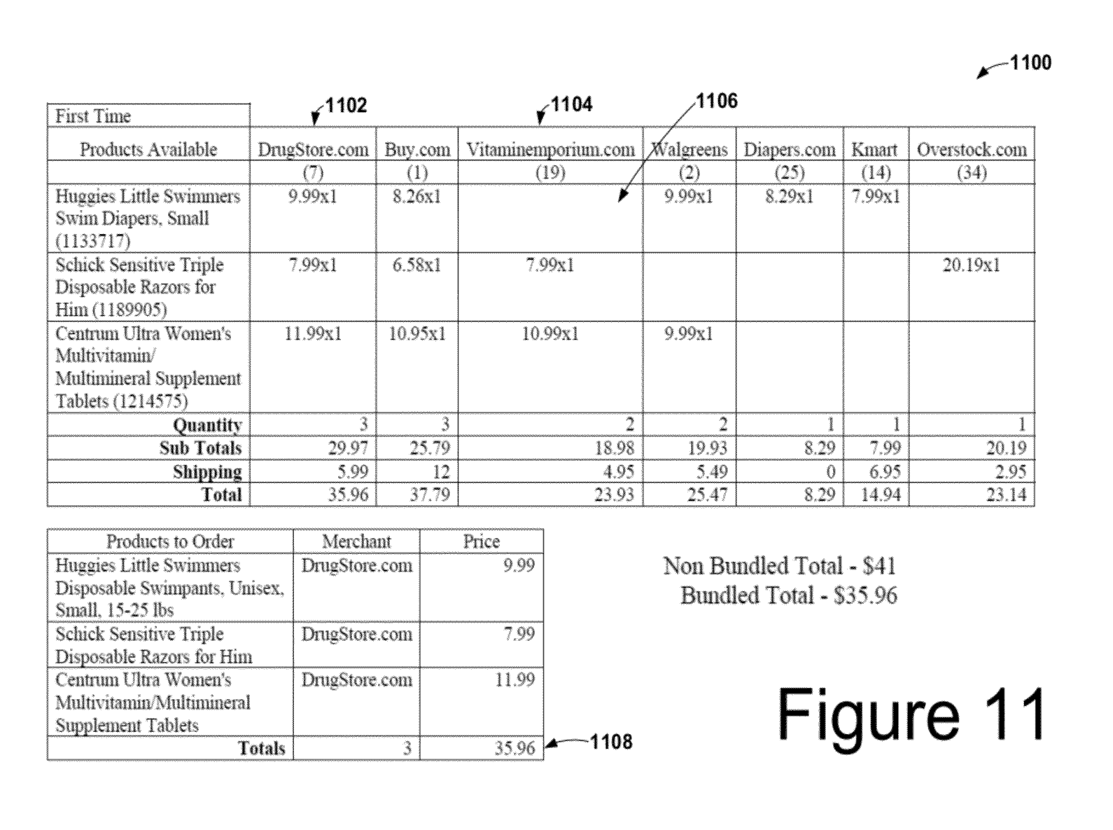

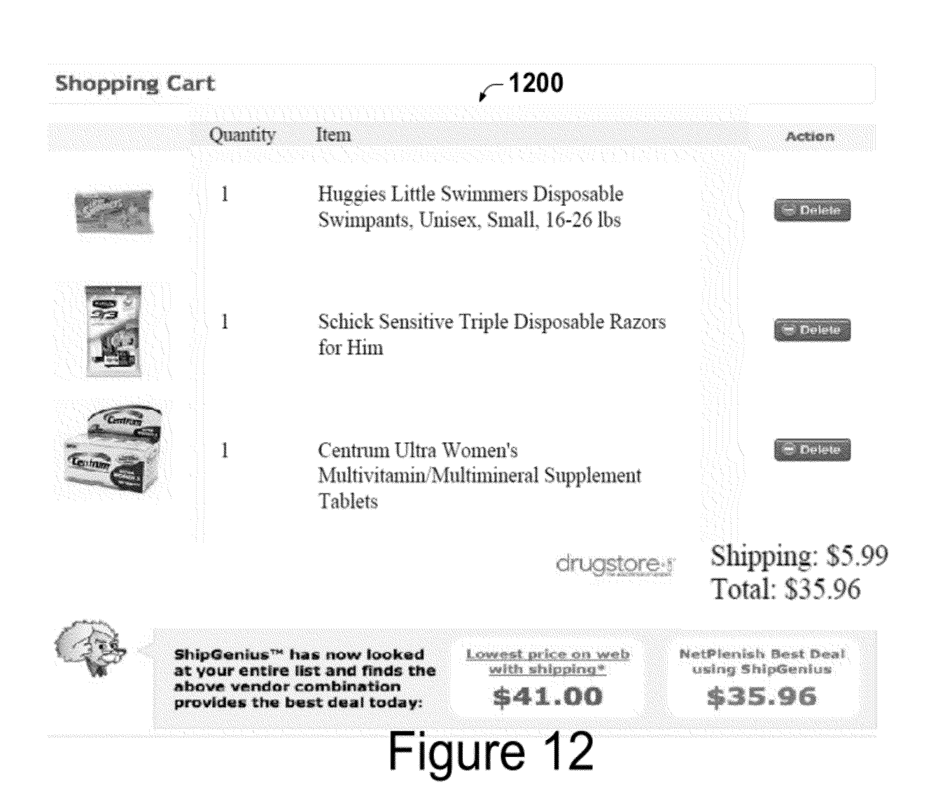

Referring back to FIG. 9, in certain embodiments, step 904 includes subsets, such as, determining a vendor with the lowest price for an individual resource and keeping track of other vendors that offer the individual resource for sale but may not have the lowest price for the individual price. FIG. 11 shows an exemplary screen shot of a User Interface 1100 in which information about offers from corresponding vendors for at least one of the resources is tracked and displayed, such as vendor DrugStore.com 1102 and vendor Vitaminemporium.com 1104. Once a plurality of resources have been examined, the host computing device 105 groups resources together in order to determine if any savings may apply for an aggregate purchase of the resources from a single vendor. In FIG. 11, vendor DrugStore.com 1102 offers all three resources for sale while vendor Vitaminemporium.com 1104 only offers two of the three resources for sale. Accordingly, vendor DrugStore.com 1102 is the vendor that offers all three resources for the lowest aggregate cost 1108 ($35.96). FIG. 12 provides an exemplary screen shot of a User Interface 1200 displaying the selected vendor.

Referring back to method 900 of FIG. 9, at step 906, all of the resources are purchased from the selected first vendor without receiving further customer input (e.g., consent of the customer to conduct the purchase from the first vendor). The host computing device 106 then completes the first purchase by sending the payment account information of the customer to the vendor with the lowest aggregate cost. Here, if the resources are being shipped together, each of the resources will have the same first specified date for delivery of the resources. Alternatively, if one or more of the resources is being shipped separately, then the one or more of the resources will have a corresponding first specified date that is different from the first specified date of delivery for the other resources.

The host computing device 106 then conducts a second subsequent search for the resources described in step 902 for delivery at a subsequent date that conforms to the specified delivery schedule of the customer. At step 904, the host computing device 106 uses the vendor search criterion to select a second vendor offering to sell each of the plurality of resources to replenish the resources. Here again, the host computing device 106 determines if any savings may apply for purchasing more than one resource from a single vendor. At step 910, the resources are purchased from the second vendor without receiving further consent of the customer to conduct the purchase from the second vendor.

Here again, if the resources are being shipped together, each of the resources will have the same first specified date for delivery of the resources. Alternatively, if one or more of the resources is being shipped separately, then the one or more of the resources will have a corresponding second specified date that is different from the second specified date of delivery for the other resources.

In certain embodiments, the order form of the selected vendor is automatically populated for the purchase and delivery of the one or more resources that the customer desires to purchase without any additional customer input. Here, the host computing device 106 automatically accesses the vendor computing device 102 of the vendor via the communication fabric 104 to place an order with the vendor. For example, the host computing device 106 access the website of the selected vendor over the Internet, using the World Wide Web Uniform Resource Locator of the selected vendor. The host computing device 106 then transmits data including the payment information of the customer and delivery address stored in the a non-transitory computer readable medium 111. The host computing device 106 further transmits the resource indicators for each of the plurality of resources that the customer desires to purchase to the vendor computing device 102. The vendor, in certain embodiments, submits the payment information to a bank to process the payment transaction and has the plurality of resources delivered to the delivery address.

In order to process payment transactions for purchases, banks sometimes require a security code (e.g., Card Verification Value or “CVV”) associated with the payment information of the customer. For example, when a customer wishes to purchase a resource from a vendor for the first time, the customer provides the following data about the charge card: a unique charge card number; an expiration date for the charge card; a billing address; and a CVV. Due to the sensitive nature of such security codes, however, many banks and transaction processors regulate the use and storage of the security code by third-parties. Often vendors don't require the security code when the customer makes subsequent purchases from the vendor because the vendor has a history with the particular customer, and is able to assess the risk of a default for the subsequent purchases. However, when a third party brokers a plurality of first time purchases by a customer from a plurality of vendors, each of vendor requires the security code for the payment account of the customer prior to processing the first time purchase.

In certain embodiments, the customer computing device 116 stores the security code associated with the payment information, such as at the direction of the customer, in the data repository 142 of the a non-transitory computer readable medium 141 and transmits the security code to the host computing device 106 via the communication fabric 114 prior to the completion of a purchase from a vendor. For example, prior to or while, populating an order form of the selected vendor, the host computing device 106 sends a transmission to the customer computing device 116 querying for the security code associated with the payment information. The security code is retrieved from the data repository 142 and transmitted back to the host computing device 106. The host computing device 106, in turn, forwards the security code to the vendor computing device 102, such as by including the security code when populating the order form of the selected vendor.

In certain embodiments, the security code is automatically transmitted to the host computing device 106. For example, the query to the customer computing device 116 includes an instruction to the customer computing device 116 to retrieve the security code from the data repository 142 without any additional customer input. In yet another embodiment, the security code is transmitted to the host computing device 106 after interaction with the customer. For example, the query to the customer computing device 116 includes a request for the customer to confirm the purchase of the plurality of resources. When the customer selects to confirm the purchase, the customer's confirmation sent back to the host computing device 106 includes the security code associated with the payment information.

Alternatively or in combination, the customer manually enters the security code at a User Interface displayed on the customer computing device 116 for transmission to the host computing device 106. To illustrate, the host computing device 106 sends a transmission to the customer computing device 116 requesting the corresponding customer's confirmation to finalize an order for a resource from a vendor or to finalize a first purchase of the resource from the vendor. The transmission from the host computing device 106 enables a rendition of a query box at a display of the customer computing device 116 including the request for the customer to enter a password to indicate the customer's confirmation. In response, the customer manually enters the password into the query box rendered on the customer computing device 116 of the customer, such as entering the code “xw458szr” into the User Interface. The customer computing device 116, in turn, sends the password to the host computing device 106. The host computing device 106 matches the received password with a password previously entered by the customer and stored at the a non-transitory computer readable medium 111 of the host computing device 106. When the match is found, the confirmation is validated and the corresponding action taken. The order or purchase is then finalized, for example.

In certain embodiments, a customer's password is the security code associated with a payment information stored at the a non-transitory computer readable medium 111 of the host computing device 106. Here, the password is need not be previously stored at the a non-transitory computer readable medium 111 of the host computing device 106. Rather, the password is transmitted to the host computing device 106 that, in turn, transmits the security code to a vendor computing device 102 to process a payment towards a purchase from the vendor. To illustrate, the host computing device 106 sends a transmission to the customer computing device 116, which is a smart phone for example, requesting the customer's confirmation on whether a purchase of a resource from a vendor should be finalized. The transmission from the host computing device 106 enables a rendition of a query box at a display of the customer's smart phone including the request for the customer to enter a password to indicate the customer's confirmation of the purchase. In response, the customer manually enters the password, which is the security code (e.g., CVV) of a payment account into the User Interface rendered on the smart phone, such as entering the code “9220” into the query box. The smart phone then automatically forms a transmission for delivery to the host computing device 106 that includes the password and the phone number of the smart phone. Here, the host computing device 106 validates the confirmation by matching the received phone number of the customer's smart phone with a phone number stored in association with the customer at the a non-transitory computer readable medium 111. The password, which is the security code, is not matched with data stored in the a non-transitory computer readable medium 111 to validate the confirmation; rather, it is sent to the vendor, as the security code, to finalize the purchase of the resource from the vendor.

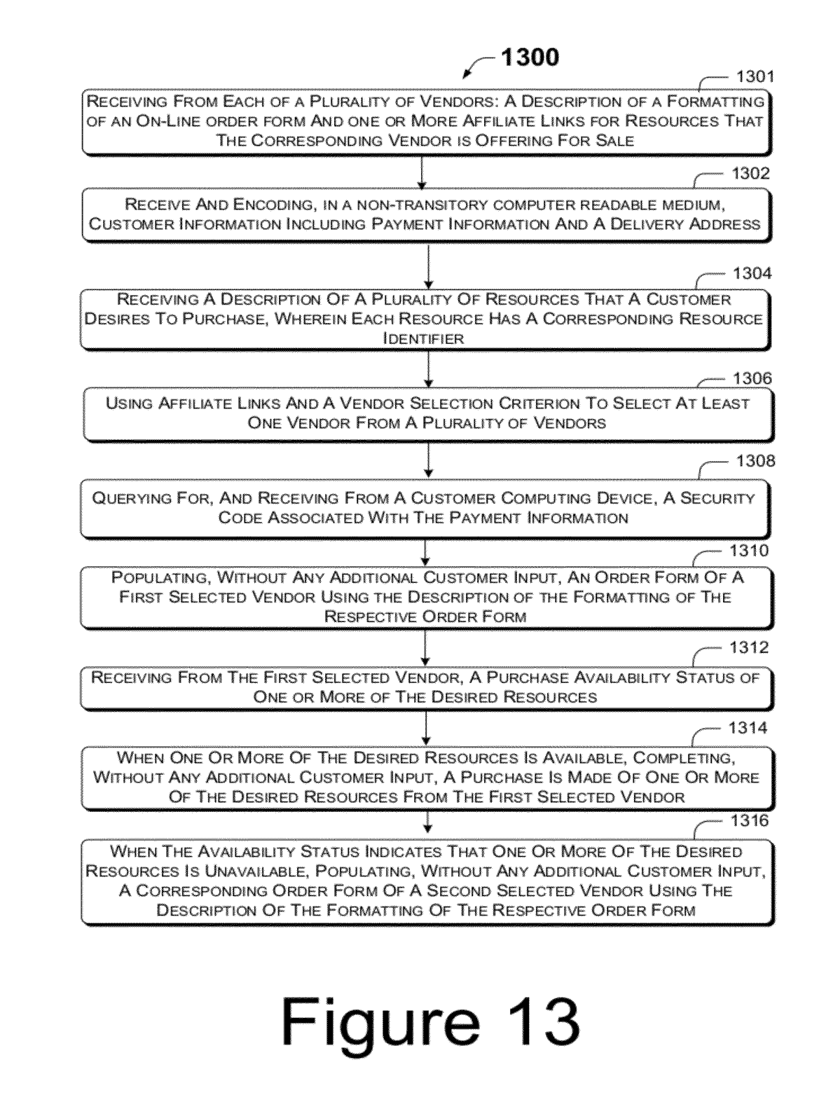

Referring to FIG. 13, a flow chart illustrates an exemplary method 1300 for selecting a vendor from which to purchase one or more desired recourses that a customer desires to purchase. At step 1301, a description of a formatting of an on-line order form and a vendor's affiliate links for resources offered for sale is received from each of a plurality respective vendor computing devices 102. The description of the formatting indicates how, and in what sequence, data is to be populated to prepare and complete the vendor's corresponding order form. For example, a description of the formatting of the on-line order form is an indication of the order form: layout, data entry fields (e.g., name, address, payment information, product UPC, and the like), corresponding sequence of data entry fields (e.g., payment first, address next), acceptable data entry formats (e.g., credit card expiration date in the format of MM/DD/YYYY), or any combination thereof.

A affiliate link of a vendor is a URL of the corresponding vendor that is created for the host. Here, a single vendor's website can have a plurality of affiliate links for a plurality of corresponding hosts that each link to the single website. For example, a first host has a first affiliate link to vendor's website “A.” Similarly, a second host has a different, second affiliate link to the same vendor's website “A.” Although they lead to the same website, each affiliate link is distinguishable from the other, consequently, the vendor has the ability to track the origin of the traffic to its website.

The special URL is used by the vendor computing device 102 to track all traffic the affiliate (e.g., the host computing device 106) sends to the vendor's website as a part of a corresponding affiliate program between the vendor and the affiliate. Here, the affiliate program includes a revenue-sharing plan where an online automated marketing program lets the host computing device 106 to access a website of the vendor that includes information about the resources the vendor is offering for sale. Because the affiliate link includes the identifier of the host, the vendor computing device 102 is able to track the origin of the query for the website. The host, in turn, receives a referral fee and/or commission a vendor desired action, such as a purchase. Vendors invest in affiliate programs for lead generation, and, of course, sales.

Typically, a URL string has a domain name, a port number, a path, a query string, and a fragment identifier in the following format: “www.domain_name:port/path?query_string#fragment_identifier.” In certain embodiments, the vendor's affiliate link string includes at least one of the domain name, a port number, a path, a query string, and a fragment identifier that has an identifier or username of the host in the affiliate link URL (e.g., “www.domain_name:port/ID OF HOST/UPC of resource advertised on webpage”).

At step 1302, customer information is received. In certain embodiments, the customer information includes at least one of: a payment information, and the delivery address. For example, a customer uses the customer computing device 116 to access a website hosted by the host computing device 106 in order to create a customer account within the system 100 of FIG. 1 and transmit the customer information to the host computing device 106. The host computing device 106, in turn, encodes the customer information in a non-transitory computer readable medium 111.

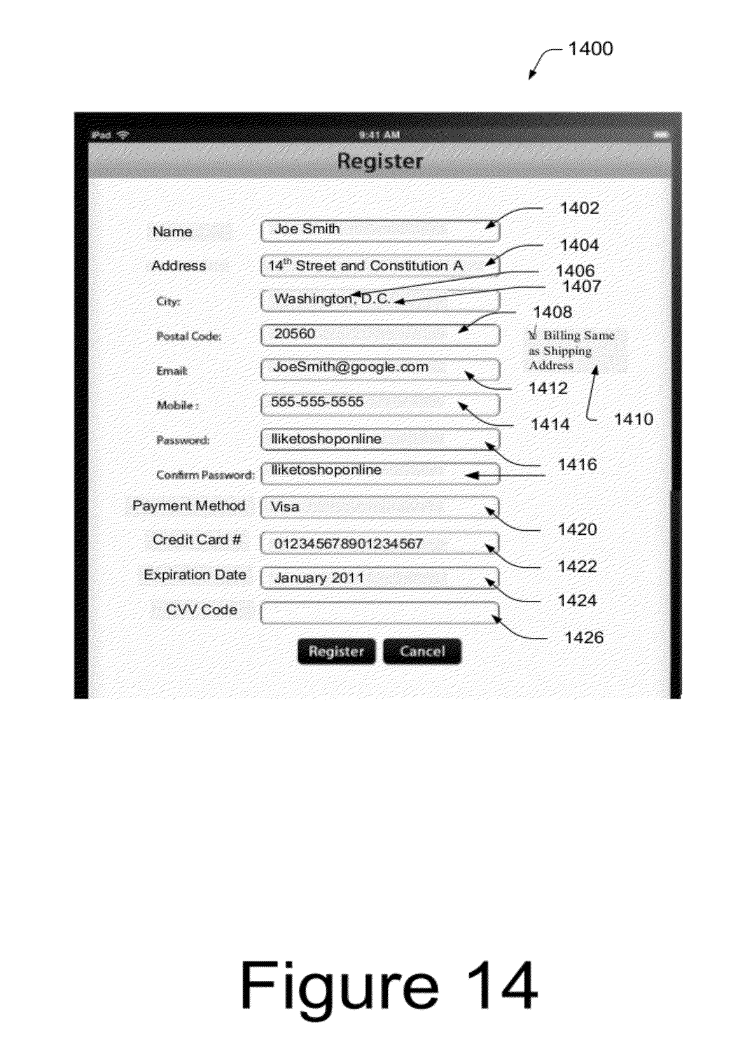

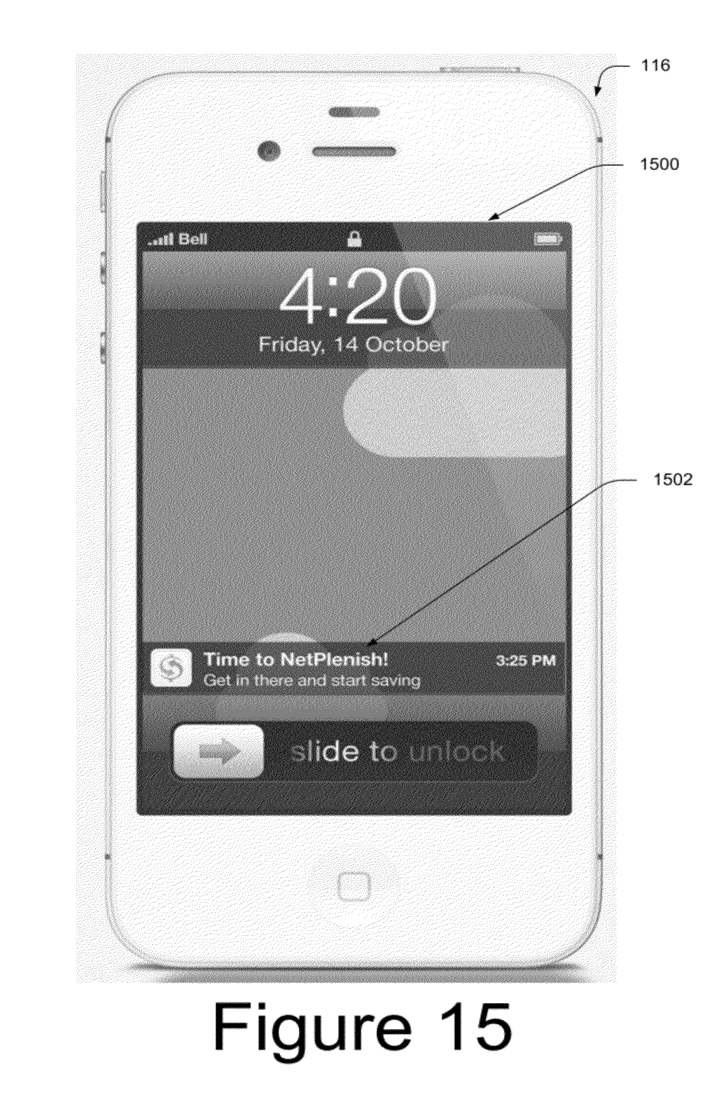

Referring to FIG. 14, a screen shot illustrates an exemplary interactive User Interface for creating a customer account within the system 100 of FIG. 1. Here, the customer uses the computing device 102 to render the User Interface using an API. The customer enters customer information that is transmitted to the host computing device 106. In the example of FIG. 14, the customer information includes: the first and last name 1402 of the customer; a billing/delivery address 1404 of the customer including the corresponding city 1406, state 1407, and postal code 1408; an email address 1412 of the customer; a phone number 1414 of the customer; a password 1416 for the registered account; and the payment information including payment method 1420, credit card number 1422, corresponding expiration date 1424, and optionally the CVV code 1426. In this example, the customer has indicated 1410 that the billing address is the same as the delivery address. In certain embodiments, as shown in User Interface 1500 of FIG. 15, the customer subsequently receives alerts 1502 regarding an opportunity to purchase resources and have them delivered to the delivery address 1404-1408.

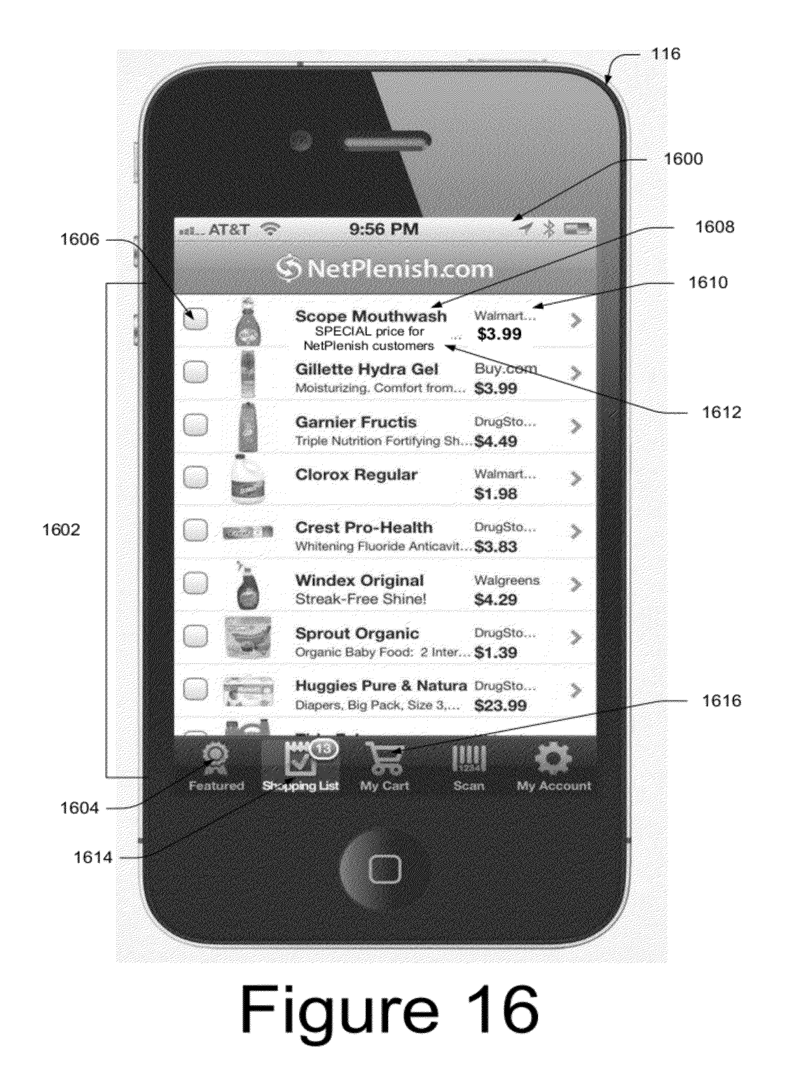

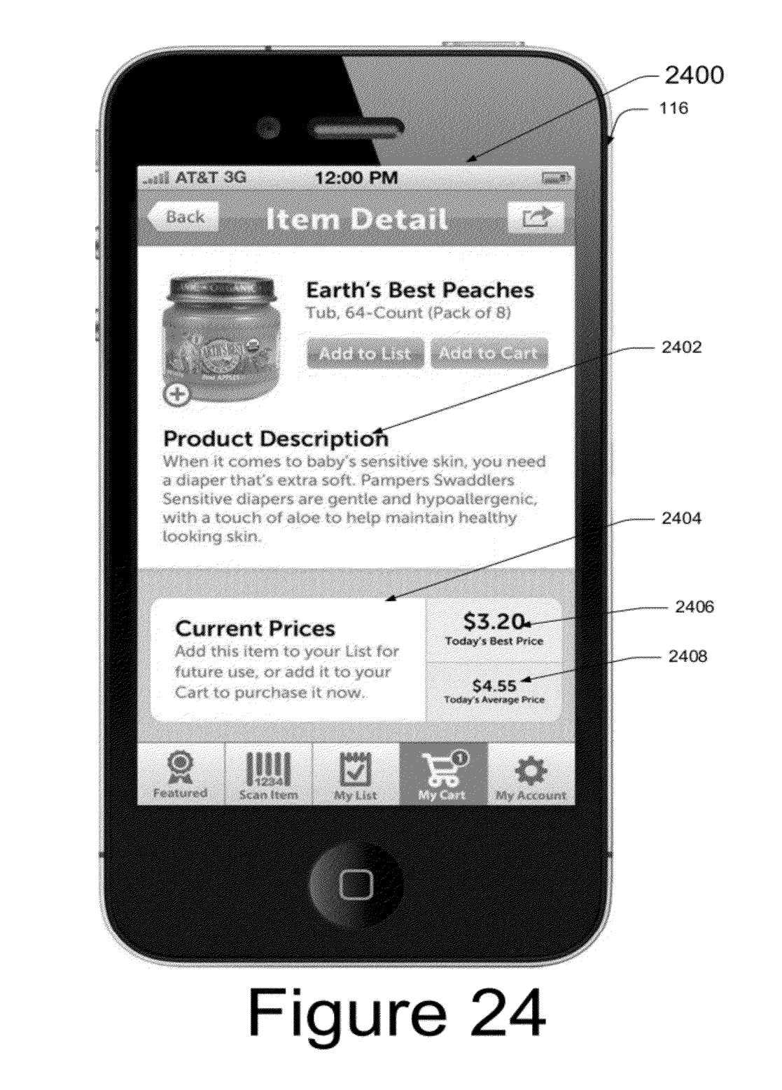

Referring back to method 1300 of FIG. 13, at step 1304, a description of one or more desired resources that the customer desires to purchase and have delivered to the delivery address is received. FIGS. 16, 17, and 24 each illustrate corresponding exemplary screen shots of User Interfaces 1600, 1700, and 2400, respectively. In FIG. 16, the customer computing device 102 (shown as smart phone 116) renders individual items 1602 within a shopping list 1604 from which the customer has the option to select 1606 resources. For example, the individual items 1602 rendered are resources previously selected from a list of resources and stored in the shopping list 1614 of the customer or scanned in using the bar scanning 1618 feature of the API for a real time, on-demand purchase. In FIG. 24, a product description 2402 gives a description of a resource available for purchase. In this illustration, a current price 2402 for the resource, the best price 2406 for the resource for the day the resource is displayed to the customer, and an average price 2408 for the resource for the day the resource is displayed to the customer. In certain embodiments, the customer is does not provide additional input to the host computing device 106 after step 1304 of FIG. 13 and the purchase of the desired resources is initiated and completed automatically.

In certain embodiments, the customer is queried for further data after step 1304 of FIG. 13 to initiate and complete a purchase of the desired resources. For example, in certain embodiments, a suggestion feature (e.g., an algorithm that is executed by the processor 110 of the host computing device 106 and/or processor 140 of the customer computing device 116) provides suggestions to the customer for resources (e.g., goods or services), in the form of featured list(s) for example, and/or individual resources that are suggested to the customer. To illustrate, the suggested feature compiles a list of one or more suggested resources based on: specials 1612 provided by participating vendors for customers within the system 100, (see also featured resources 1604), past shopping list or purchase history of the customer stored in the a non-transitory computer readable medium 111, past shopping list or purchase history of other customers that have given permission to share their respective shopping list or purchase history with the customer, or popular resources frequently selected or purchased by other customers within the system 100 of FIG. 1.

In certain embodiments, the suggestion feature measures an effectiveness of the suggested resources, such as a degree to which the customer is predicted to response favorably to the suggested resource(s). For example, the suggestion feature determines a predicted revenue for suggesting a specific resource to a customer based on several criteria of a probability equation, such as a number of times one or more customers click on the specific resource, a number of times the specific resource is added to a shopping list by one or more customers, a number of times the specific resource is added to the shopping cart, and a number of actual purchases that occur as a result of a suggestion of the specific resource. One or more of the criteria are computed based on profitability to determine a resource suggestion that the customer is most likely to respond to. In certain embodiments, the profitability equations are co-related to available demographic and behavioral characteristics of the individual customer to make the best suggested match for the customer. In order to allow for new inventory (e.g., resources) to displace the existing suggestions, a certain amount of the inventory (10% for illustrative purposes) is made available to test new suggestions to determine if the new suggestions outperform the existing suggestions.

In certain embodiments, the suggested resources list is determined by variables that impact the purchasing decisions of customers and the quality of the customer's interactions with the service, such as suggesting resources having brands that correlate with brands purchased in the past, suggestions of complementary categories of resources, or matching advertiser's interest in reaching one or more customers with the advertiser's resource introductions.

In certain embodiments, each of the resources in the shopping list (e.g., shopping list 1614 of FIG. 16) has a corresponding resource identifier, such as a unique alphanumeric code that is associated with the corresponding resource (e.g., SKU or UPC). For example, the resource identifier is coded to include an identifier of the host (e.g., “netplenishitem45788993” or the affiliate link for the resource). Consequently, when sent to the selected vendor from which the resources are ultimately purchased, the selected vendor can identify not only the resource being purchased but the host from which the purchase initiated (e.g., “netplenish”).

In certain embodiments, the vendor, in turn, uses the coded resource identifier, such as the affiliate link, to identify the host and log the transaction in association with the host in order to subsequently submit a commission to the host for initiating the sale. For example, when the resource with the resource identifier including “netplenish/item45788993” is purchased from the vendor for $50.00, the vendor pays the host “netplenish” 10% of the sale, which is $5.00 in this example. Other commissions are also contemplated. For example, the commission is a percentage of the purchase price selected from the group consisting of: about 0 to 90%; about 5% to 80%; about 10% to 60%; about 15% to 50%; and 2% to 20% of the purchase price.

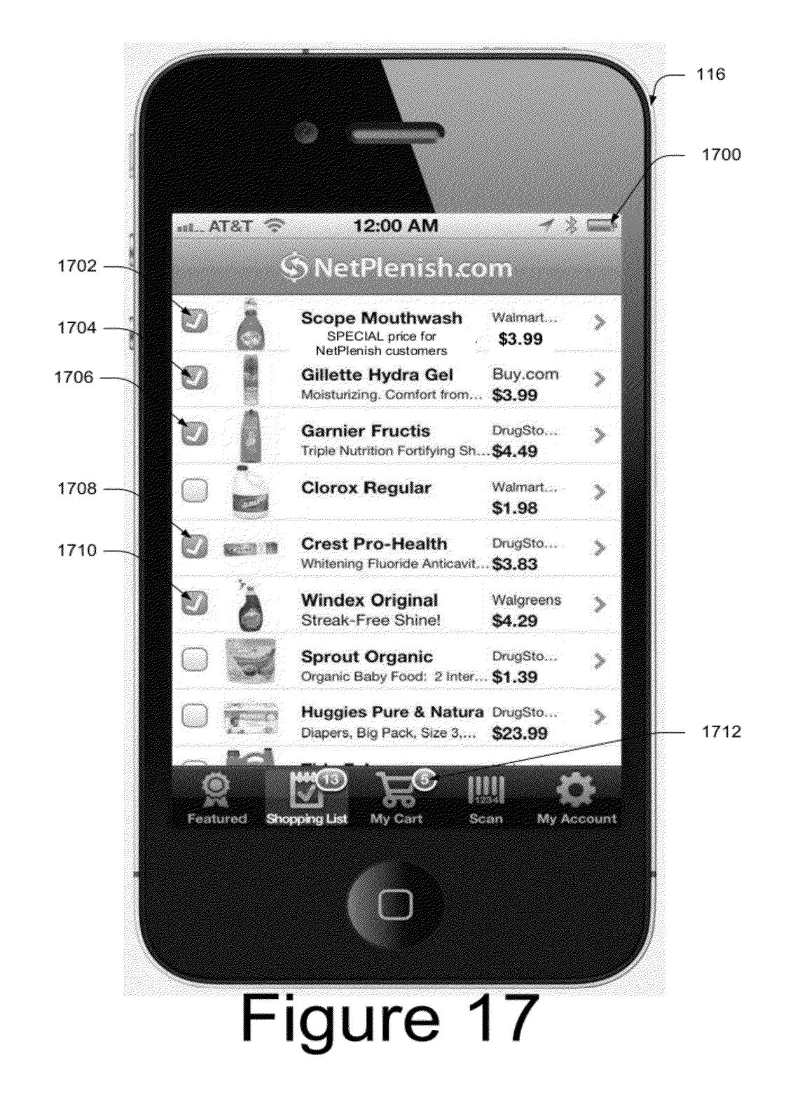

In the example of FIG. 17, the customer has selected five resources for purchase and delivery to the delivery address. Here, the first selected resource 1702 is a mouthwash, the second selected resource 1704 is a shaving gel, the third selected resource 1706 is a shampoo, the fourth selected resource 1708 is a toothpaste, and the fifth selected resource 1710 is a window cleaner, each of which are added to the shopping cart 1712 of the customer. Although not shown in FIG. 17, each resource in the shopping cart 1712 is associated with a resource identifier, such as, for example: NetUPC123456789999; NetUPC763646789999; NetUPC123456266699; NetUPC123993529999; and NetUPC123456873610 respectively or corresponding affiliate links having URL strings that include the same.

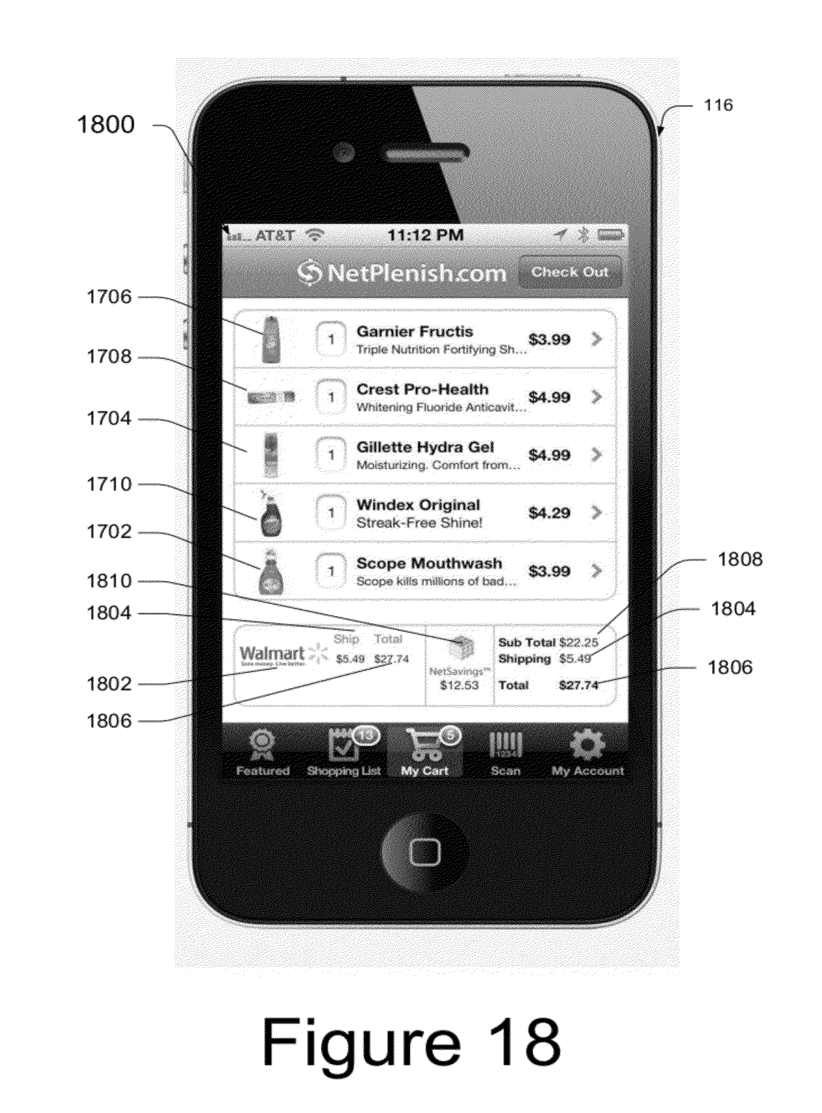

Referring back to method 1300 of FIG. 13, at step 1306 the affiliate links and/or vendor selection criterion is used to select at least one vendor from a plurality of vendors each offering to sell one or more of the desired resources. For example, the host computing device 106 follows the affiliate links of a plurality of vendors each corresponding to websites of a respective of vendors, each offering to sell all five of the resources in FIG. 17 (resources 1702-1710) selected by the customer. Assuming the vendor selection criterion is lowest cost, for example, the host computing device 106 calculates the aggregate cost to purchase and have delivered all five resources to the delivery address for each of the vendors selling all five resources less any savings due to purchasing all of the resources from the respective vendor. The host computing device 106 then determines which vendor, from among the vendors selling all five resources, will sell and deliver the resources for the lowest aggregate cost. Referring to FIG. 18, the host computing device 106 has determined that the vendor “Walmart” 1802, is selling all five resources and will have them delivered (shipping cost 1804) to the delivery address for the lowest cost 1806. Here, the User Interface 1800 also shows an amount saved 1810 by purchasing all five resources together rather than individually.

Although a lowest cost vendor selection criterion is illustrated in FIG. 18, other vendor selection criterion are also contemplated, as stated previously. For example, in certain embodiments, the host computing device 106 predetermines that the vendor selection criterion are vendors that have received the highest ranking from a plurality of customers for safe delivery of resources. In yet another embodiment, the customer identifies and transmits the vendor selection criterion to the host computing device 106, such as by selecting at, and transmitting from, the customer computing device 116 the vendor selection criterion as vendors that have at least a 90 day resource return policy, for example.

In certain embodiments, more than one vendor is selected at step 1306. For example, if the vendor selection criterion is vendors that are offering one or more of the desired resources for a price below the average price for the respective resource, then one or more vendors are selected, each offering a price below the average price.

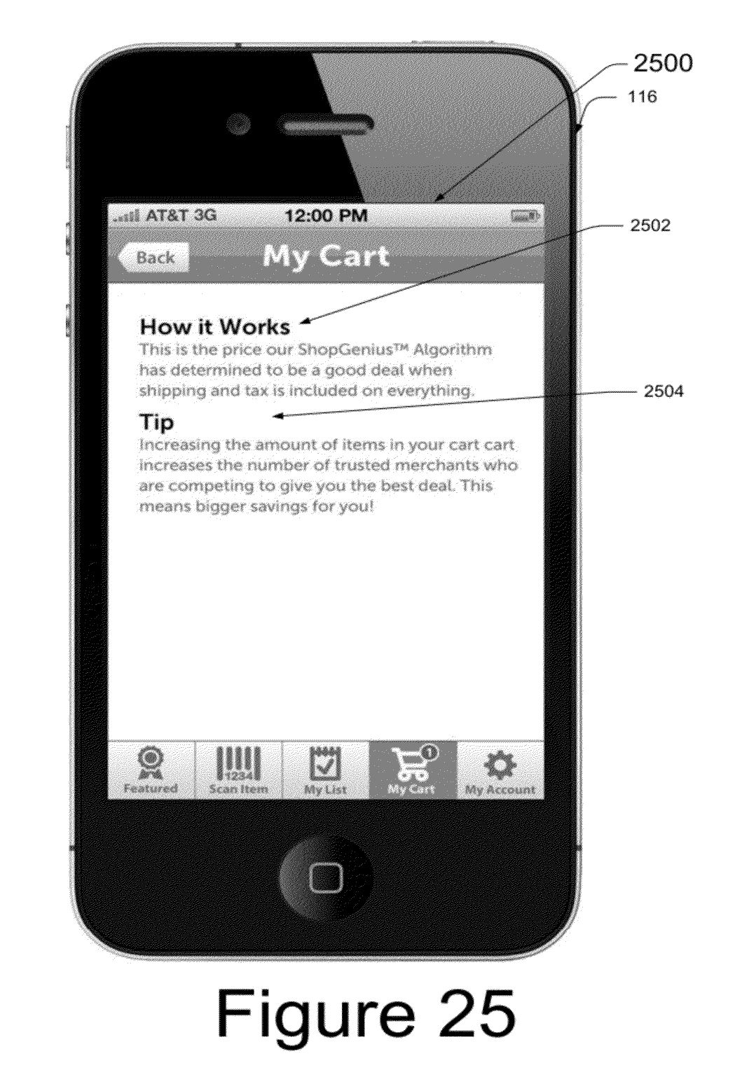

Referring to FIG. 25, a User Interface 2500 renders a notification 2502 to the customer. In this example, the customer receives a notification 2502 indicating that the lowest cost 1806 of FIG. 8 is a price determined when all of the resources desired by the customer are purchased from a single vendor. The customer is further given a tip 2504 that if the customer selects further resources to purchase, the savings may be higher because more the vendor selection criterion is used across a wider range of vendors.

In certain embodiments, the customer the notification 2502 to the customer is an indication that the customer should expect to pay about an estimated price or less for the one or more desired resources. Here, the host computing device 106 determines the estimated price by analyzing corresponding prices for the desired resources obtained from the affiliate links. For example, the host computing device 106 determines the estimated price by calculating an average price offered by vendors for a first item among the desired resources is $US4.55 (element 2408 of FIG. 24). Other means for determining the estimated price are also contemplated, such as calculating a medium price, and the like, that is then included in the notification.

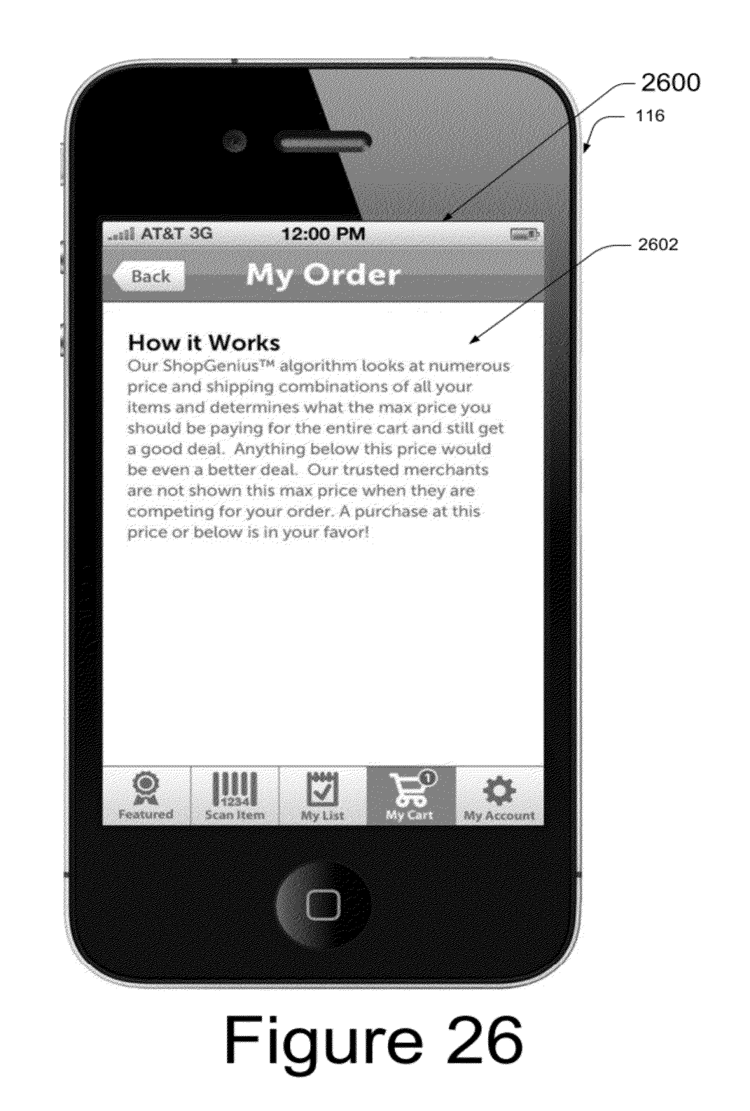

Referring to FIG. 26, in certain embodiments, vendors compete to provide the best deal for a customer's purchase of a plurality of resources. In FIG. 26, a User Interface 2600 renders information 2602 about savings to the customer due to vendor competition. In certain embodiments, the savings due to vendor competition is in addition to the savings due to purchasing all five resources from vendor rather than purchasing them individually (e.g., amount saved 1810 of FIG. 18). The rendered information 2602 indicates that the lowest cost 1806 of FIG. 18 is a maximum price that the customer would expect to pay for the selected resources. Here, trusted merchants (e.g., trusted vendors), which may be a subset of the vendors that are capable of selling the resources to the customer, are given an opportunity to compete for the customer's order of the plurality of resources.

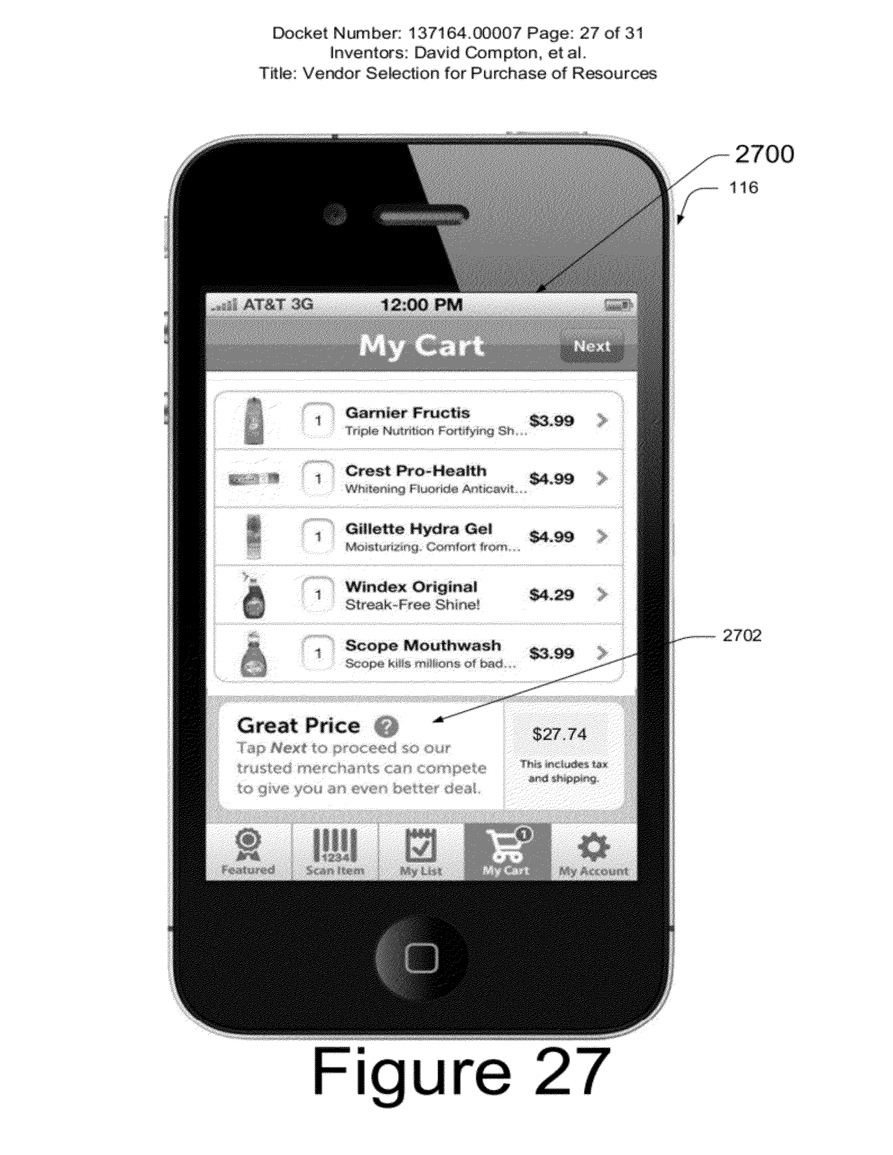

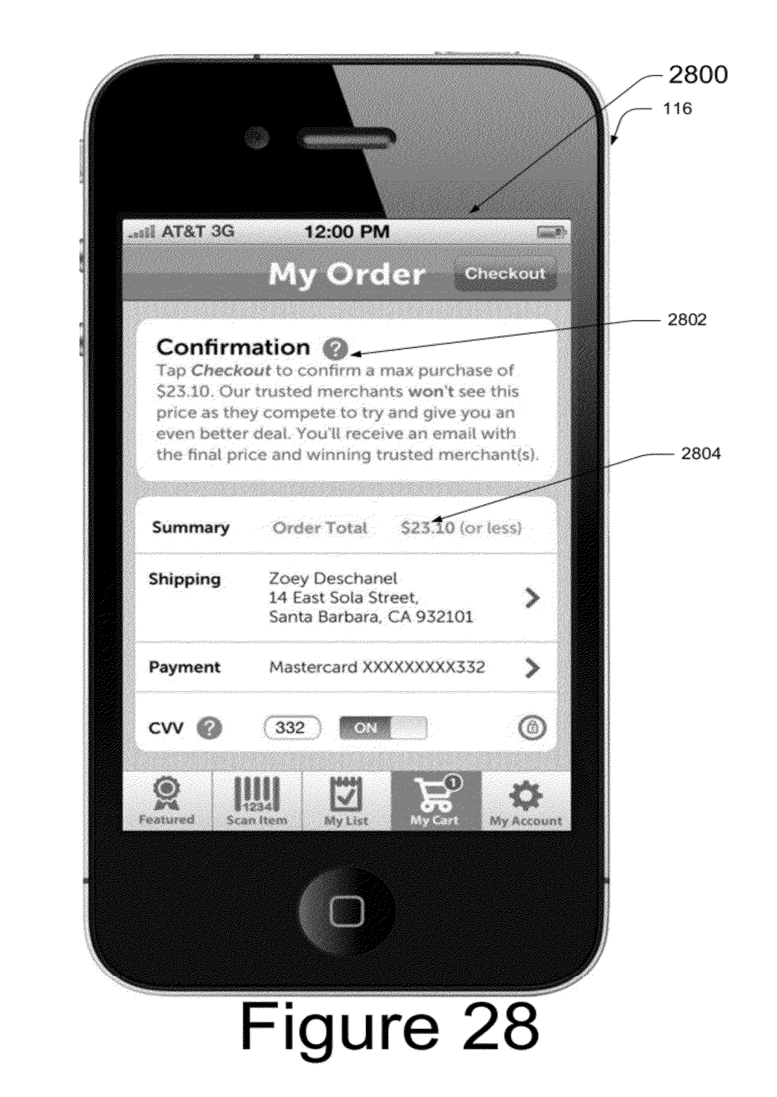

In certain embodiments, the host computing device 106 executes an algorithm that is in line with a trusted merchant's business rule, which is to be applied when competing for a customer's order. To illustrate, Merchant 1 (e.g., vendor 1) has a business rule: “when more than five resources are being purchased by one customer, we will give the customer a 5% discount on the total cost for the plurality of resources,” while Merchant 2 (e.g., vendor 2) has a business rule: “if the plurality of resources of interest to the customer includes more than one quantity of a single resource, the second item is sold for half the price of the first item.” Other business rules are also contemplated. Here, the host computing device 106 would execute the algorithm to determine if Merchant 1 or Merchant 2's business rules will result in a further savings to the customer. Referring to FIG. 27, the User Interface 2700 rendered on the customer computing device 116 gives the customer an option 2702 to allow trusted merchants to compete for the customer's order. In FIG. 28, the User Interface 2800 renders a confirmation 2802 to the customer indicating that trusted merchants will be given an opportunity to compete for the customer's order. As previously stated, the final order total 2804 for the purchase of the plurality of resources will be at, or below, the lowest cost 1806 in FIG. 18.

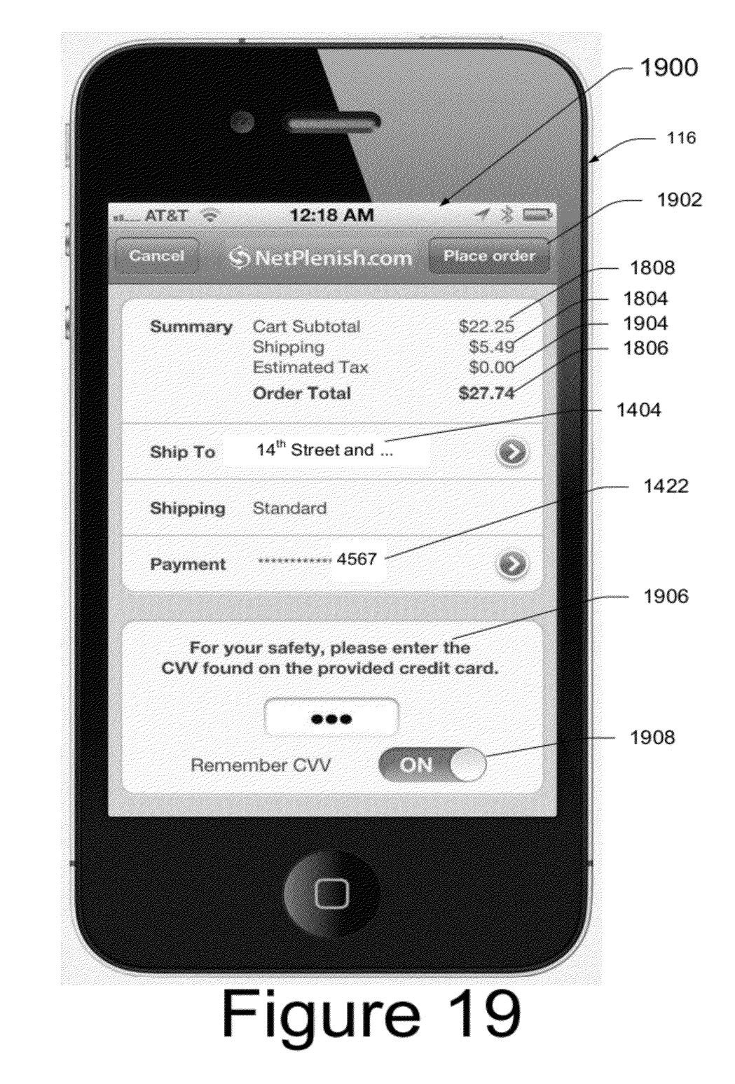

In certain embodiments, at step 1308 the customer computing device 116 is optionally queried for the security code associated with the payment information. As stated previously, in certain embodiments, the query includes an instruction to the customer computing device 116 to retrieve the security code from the a non-transitory computer readable medium 141 of the customer computing device 116 without manual customer input. In other embodiments, the query prompts the customer to manually input the security code into the customer computing device 116. In FIG. 19, a screen shot of User Interface 1900 includes a query 1906 to the customer to manually enter the security code, shown as CVV. In the embodiment of FIG. 19, the customer is given an option to store 1908 the security code data repository 142 in the a non-transitory computer readable medium 141 of the customer computing device 116. In this manner, a manual customer input for the security code is no longer needed for subsequent purchases because the security code is retrievable from the data repository 142. Whether manually entered or automatically retrieved, the customer computing device 116 transmits the security code to the host computing device 106.

Referring to FIG. 19 and method 1300 of FIG. 13, at step 1308, the security code is optionally received from the customer computing device 116. In certain embodiments, a query is sent to the customer requesting confirmation of the purchase to which the customer responds by sending the confirmation back, such as back to the host computing device 106. Similarly, in FIG. 19, the customer transmits a confirmation for the purchase to the host computing device 106 when selecting the “place order” 1902 option. As stated previously, in certain embodiments, the confirmation of the purchase includes the security code. In the example of FIG. 19, when the customer selects the “place order” 1902 option a transmission is formed for delivery to the host computing device 106 including both the confirmation and the security code.

Referring back to method 1300 of FIG. 13, at step 1310, an order form of at least one vendor selected in step 1306 is automatically populated using the description of the formatting of the respective order form of the selected vendor. In certain embodiments, the order form is populated for the purchase and delivery of all of the desired resources from the selected vendor without any additional customer input. The order form is populated with, for example, the customer information encoded in the a non-transitory computer readable medium 111, the security code, and the resource identifiers for each of the plurality of resources desired by the customer, without querying the customer to fill out or provide data for the order form.

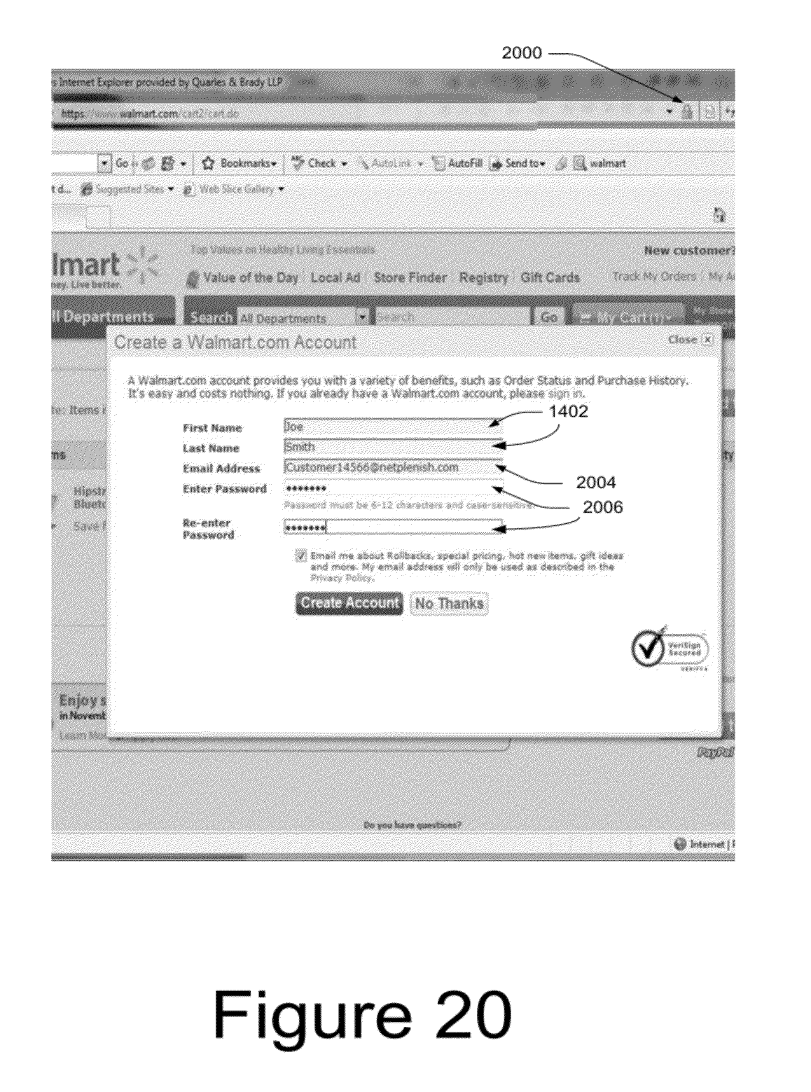

To illustrate, the host computing device 106 access a website of the selected vendor to automatically create an account and place the order for the plurality of resources. Referring to FIGS. 20-22, screen shots of User Interfaces (2000-2200, respectively) illustrate the creation of an on-line account and the automatic population of an on-line order form of the selected vendor “Walmart.” In certain embodiments, User Interfaces 2000 to 2200 are not rendered on the customer computing device 116 and remain hidden to the customer.

For example, the host computing device 106 retrieves the payment information encoded in the in a non-transitory computer readable medium 111 (e.g., stored in the data repository 112) in association with the customer (e.g., step 1302 of method 1300). The host computing device 106 creates an instance of a browser, which then downloads the relevant web-page HTML, images and JavaScript files to the host computing device 106 to place an order from the vendor computing device 102. The agent software interacts with the browser instance to locate interactive form elements within each web-page, populating these with the information, such as the payment information, to complete the order. In certain embodiments, this interaction with the browser is accomplished using client-side software running on the host computing device 106 which interacts directly with the browser instance through a plug-in. This software adaptively responds to account and order state to accomplish the sequence of operations to complete a checkout. Each transaction creates a session with a lifespans encompassing all the web-pages generated by the vendor's on-line ordering process until the order is completed and confirmation obtained. To illustrate, the on-line form is populated with the name 1402, address 1404, city 1406, state 1407, and ZIP code 1408 received and encoded in the non-transitory computer readable medium 111 (e.g., stored in the data repository 112) at step 1302 of the method 1300 of FIG. 1300 and in FIG. 14.

In FIG. 20, an account is created with the selected vendor by populating, without further customer input, a website of the vendor for creating a vendor account. Here, the input boxes in the on-line account creation form of the selected vendor is shown as automatically populated with the customer information received at step 1302 of method 1300 and FIG. 14. For example, the first and last name input box is populated with the first and last name 1402 received in FIG. 14. In this example, the password 2006 and email address 2004 input box is populated with a password and email address of the host, respectively, not that of the customer (e.g., not email address 1412). In this manner, the host manages correspondence from the selected vendor (e.g., shipping tracking number . . . etc.), minimizing further customer input for the processing of the purchase or shipment of the plurality of resources.

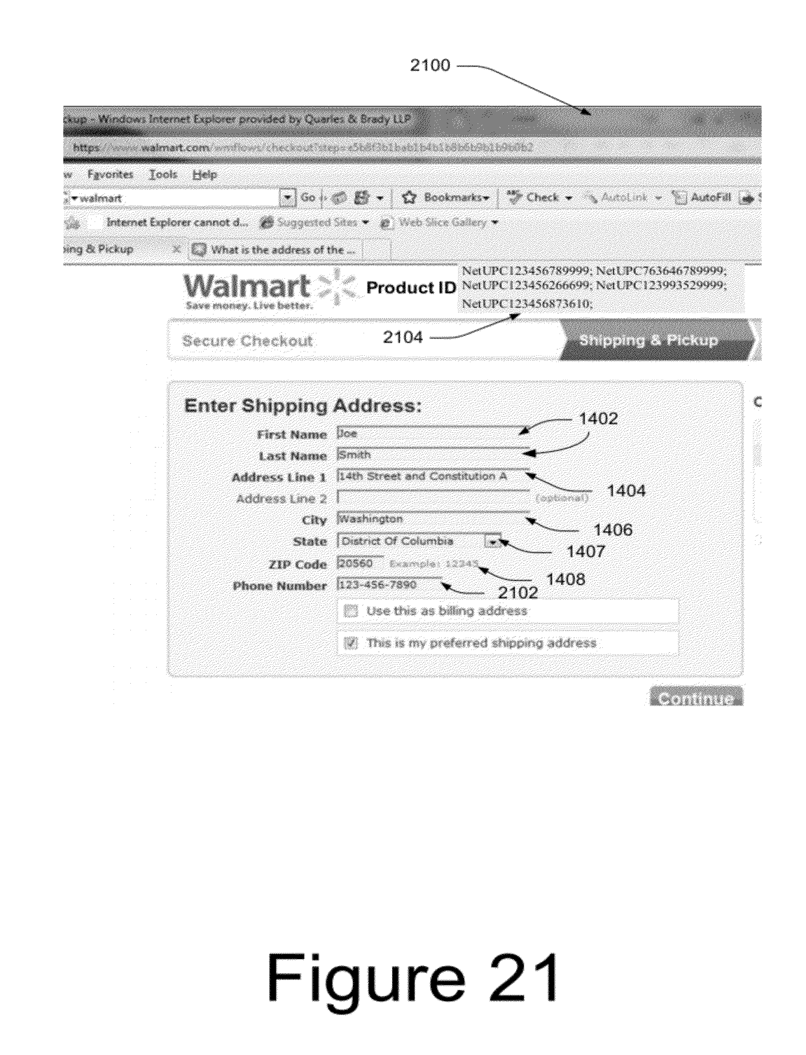

In FIG. 21, a portion of the on-line order form of the selected vendor is populated with the delivery address stored in the in the non-transitory computer readable medium 111 of the host computing device 106. For example, the host computing device 106 retrieves the delivery address information stored in the data repository 112, of the in a non-transitory computer readable medium 111, in association with the customer. The host computing device 106 creates a file, containing the delivery address and other customer order information, that is then transmitted to the vendor computing device 102. The vendor's on-line form is, in turn, populated with the delivery address. To illustrate, the on-line form is populated with the name 1402, address 1404, city 1406, state 1407, and ZIP code 1408 received and encoded in the non-transitory computer readable medium 111 (e.g., stored in the data repository 112) at step 1302 of the method 1300 of FIG. 1300 and in FIG. 14.

Referring back to FIG. 13, at step 1312, a purchase availability status of one or more of the desired resources is received from the vendor selected at step 1306. Here, the vendor computing device 102 sends to the host computing device 106 a transmission including data indicates if one or more of the desired resources is available, such as in-stock, in transit to warehouse and available in 24 hours; or unavailable, such as out-of-stock, recalled and the like. At step 1314, when one or more of the desired resources is available for purchase from the selected vendor, the one or more of the desired resources is purchased from the selected vendor. For example, the on-line order form is automatically completed, without further input from the customer, such as by providing the customer's payment information, or a confirmation is sent to the selected vendor to authorizing the completion of the purchase.

At step 1316, when one or more of the desired resources is unavailable for purchase from the selected vendor, the order form of a second, different selected vendor (from step 1306) is populated without any additional customer input. Here, the order form of the second selected vendor is automatically populated using the corresponding description of the formatting of the second selected vendor. The method 1300 then repeats steps 1312 to 1316 for the second selected vendor and subsequent vendors until the one or more desired resources are available for purchase.

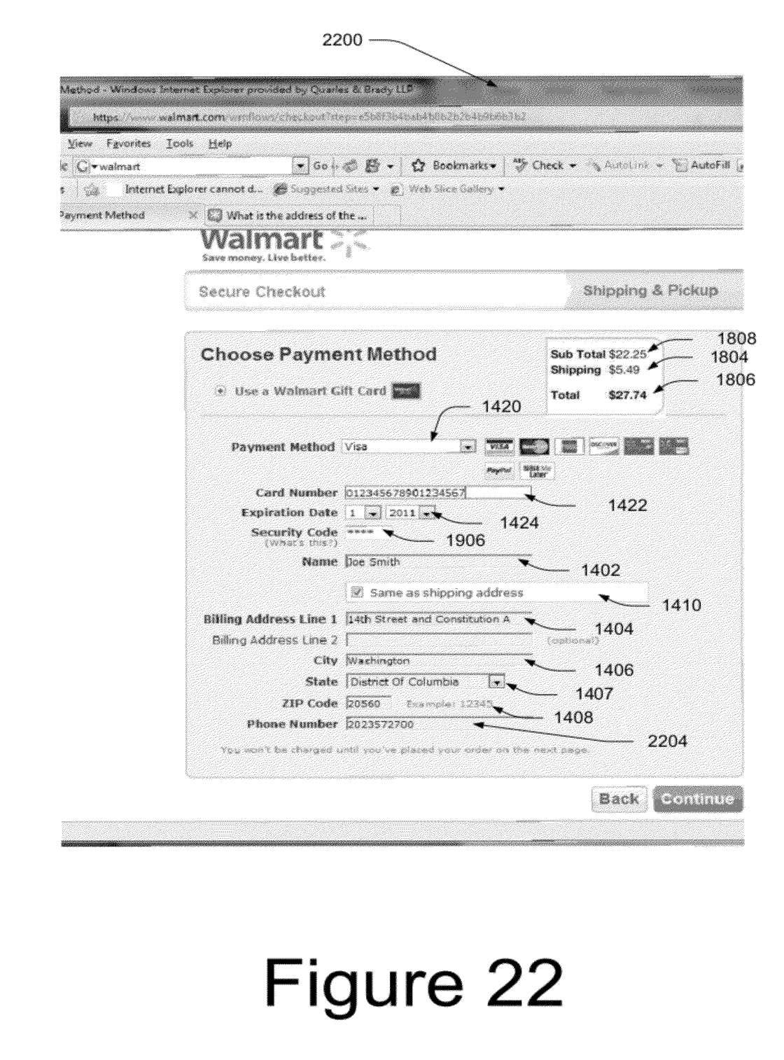

In FIG. 22, a portion of the on-line order form of the selected vendor is automatically populated with the payment information of the customer. The illustrated example of FIG. 22 shows the on-line form of the vendor “Walmart” populated with: the payment method 1420; card number 1422; expiration date 1424; customer name 1402; and customer's billing address 1410 (e.g., 1404-1408). Moreover, in FIG. 22, the on-line form of the selected vendor is further populated with the security code 1906 transmitted to the host computing device 106 from the customer computing device 106 (see, e.g., FIG. 19 query 1906), and the resource identifiers of the five resources 2104 identified at step 1304 of method 1300 of FIG. 13 and illustrated in FIGS. 17 (1702-1710) and 18. In this example, a contact phone number 2204 for the host is also included in the on-line form. The on-line form is completed and transmitted to the vendor computing device 102 for processing and fulfillment, such that the plurality of resources are purchased from the selected vendor and the delivered to the delivery address.

To illustrate, in certain embodiments, the customer optionally initiates a price matching sequence by viewing resources on the customer's customer computing device 116. A notification is optionally displayed on the customer computing device 116. Upon viewing the notification, the customer views one or all of: a shopping list, featured list, shopping cart, a resource detailed view. Each view creates a refreshed price comparison from the a non-transitory computer readable medium 111 associated with the host computing device 106, matching a known or predicted interest of the customer, such as an implied or explicit interest, in one or more resources. The customer confirms this match by adding a resource to the shopping list or shopping cart, by placing an order on the shopping cart and checkout page against that match, or a combination thereof.

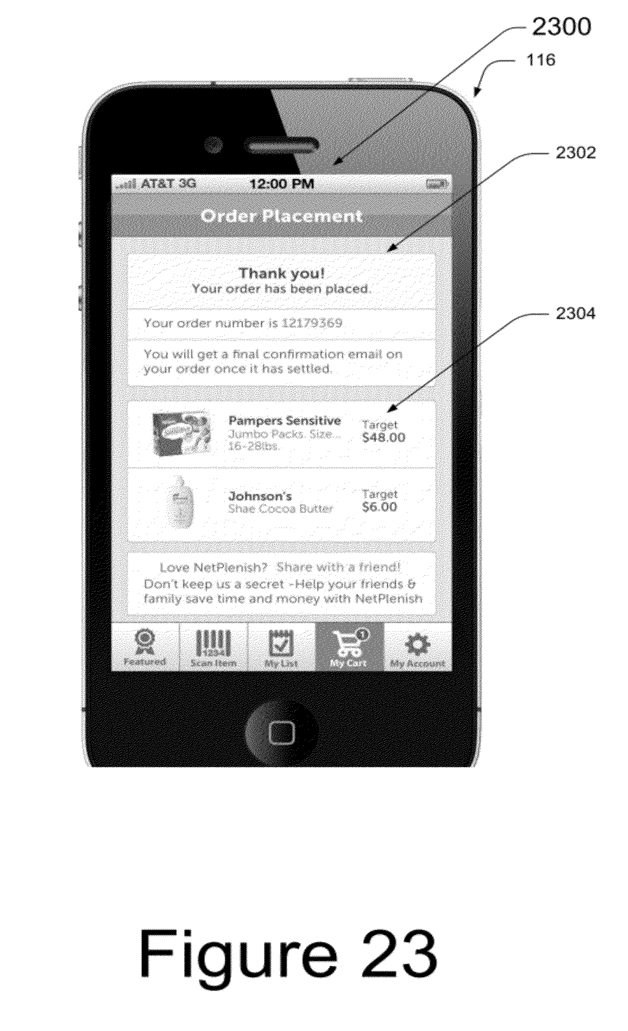

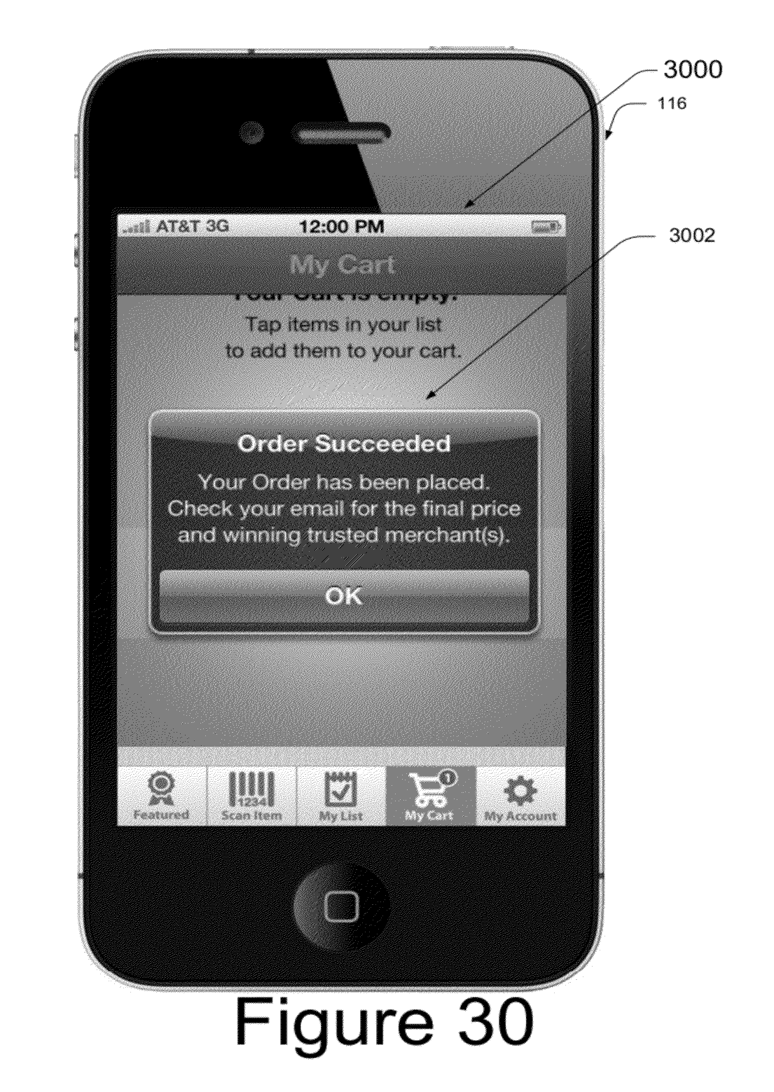

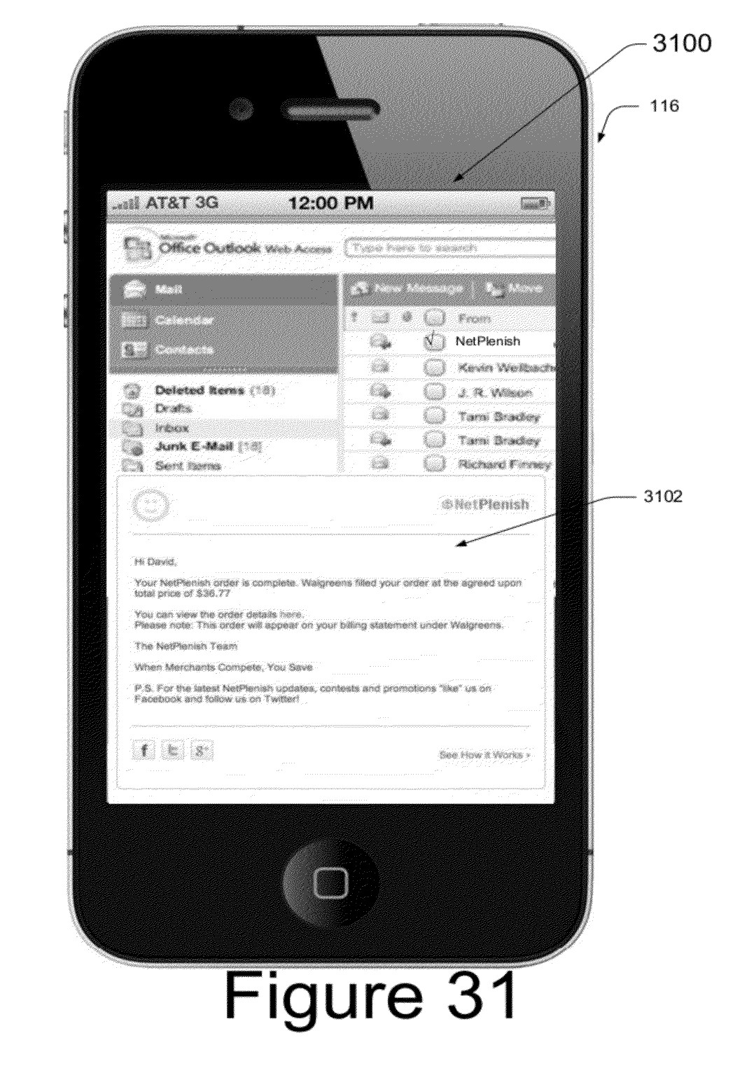

In certain embodiments, the customer receives an order placement notice that the on-line form has been submitted to the host computing device 106. In FIGS. 23 and 30, a screen shot of User Interface 2300 and 3000 illustrates a completion notice 2302 and 3002, respectively, that is rendered on the customer computing device 116. In certain embodiments, an email notification re same is sent to an email service of the customer, such as email 3102 displayed within user interface 3100 on the customer computing device 116.

Upon completion of the order placement process, the customer computing device 116 communicates with the host computing device 106 that, in turn, initiates the process illustrated in FIGS. 20-22. Upon a successful completion of the order placement on the vendor computing device 102, the customer receives a confirmation email that the order has been successfully processed. In FIG. 23, advertisements for other resources 2304, such as featured resources or suggested resources, is rendered on the customer computing device 116.

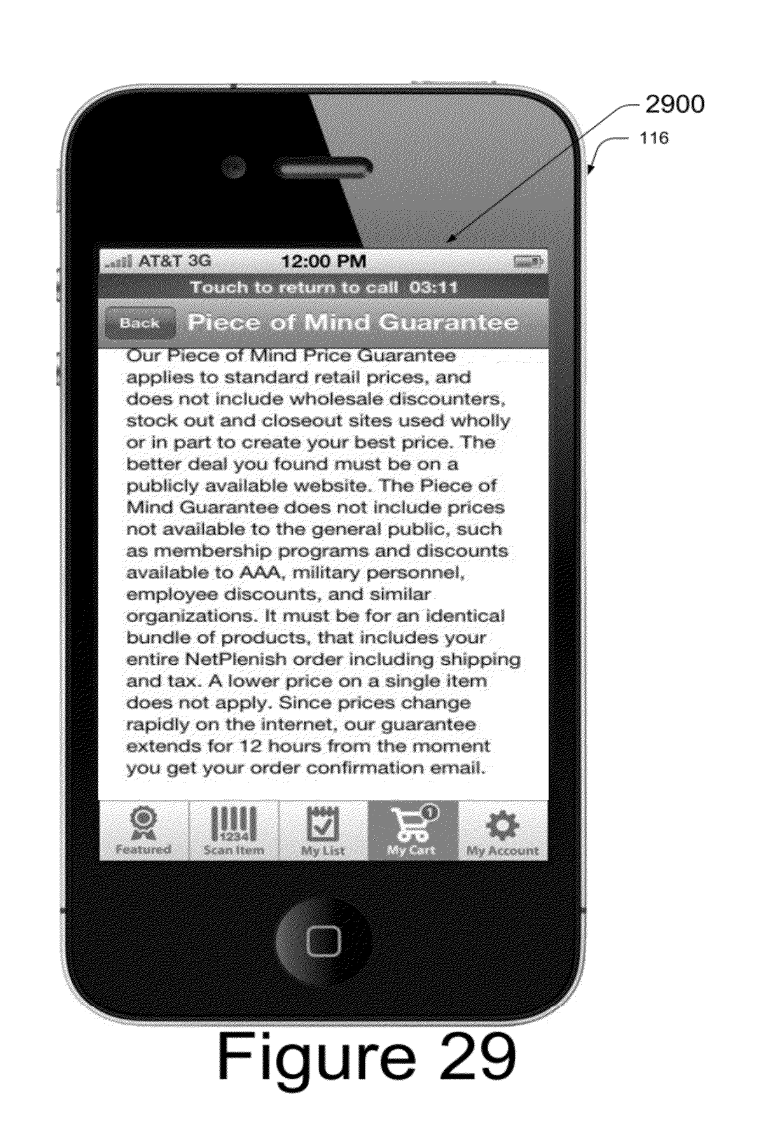

In the event that one or more errors occurs, or if there is a material difference in the order settlement in comparison to the order placement (or estimated price quoted in the notification 2502 of FIG. 25), the customer receives an email, an SMS alert or a notification that the customer's approval is required in order to complete the order. In certain embodiments, a disclaimer is sent to the customer computing device 116 for rendition as user interface 2900 of FIG. 29.

At certain embodiments, a transmission is received including data about a commission that is earned in association with the purchase of the plurality of resources from the selected vendor. As stated previously, in certain embodiments, the host receives a commission for directing a customer to purchase resources from a selected vendor, such as a commission of 12% of the purchase price. To illustrate, in the example of FIG. 22, the total price for the purchase of the plurality of resources, prior to shipping costs, is illustrated as $USD22.25 (illustrated as element 1808 in FIG. 18). Here, the host receives 12% of $USD22.25 or $USD4.90.

Although FIG. 13 illustrates Applicant's method for selecting vendors to purchase one or more desired resources of a customer in an on-line website setting, other embodiments are also contemplated. To illustrate, the steps 1301 to 1316 can be implemented using an API that has access to the vendor's database and a corresponding order form is populated that is not available on-line, on the Internet.

It should be understood that the present invention can be implemented in the form of control logic, in a modular or integrated manner, using software, hardware or a combination of both. The steps of a method, process, or algorithm described in connection with the implementations disclosed herein may be embodied directly in hardware, in a software module executed by a processor, a web-server, or in a combination of the two. The various steps or acts in a method or process may be performed in the order shown, or may be performed in another order. Additionally, one or more process or method steps may be omitted or one or more process or method steps may be added to the methods and processes or one or more process or method steps may be added from other methods and processes herein described. An additional step, block, or action may be added in the beginning, end, or intervening existing elements of the methods and processes. Based on the disclosure and teachings provided herein, a person of ordinary skill in the art will appreciate other ways and/or methods to implement the present invention.

In certain embodiments, an article of manufacture, such as and without limitation computing device 106, comprises instructions, such as instructions 126 (FIG. 1) encoded in a non-transitory computer readable medium 111 (FIG. 1) wherein those instructions are executed by a processor, such as processor 110 (FIG. 1) to perform one or more of steps recited in one or more of FIGS. 2, 3, 4, 7, 8, 9, and 13.

In other embodiments, instructions reside in any other computer program product, where those instructions are executed by a computer external to, or internal to, system 100 (FIG. 1), to perform one or more of steps recited in FIGS. 2, 3, 4, 7, 8, 9, and 13. In either case, the instructions may be encoded in computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

It is understood that the examples and implementations described herein are for illustrative purposes only and that various modifications or changes in light thereof will be suggested to persons skilled in the art and are to be included within the spirit and purview of this application and scope of the appended claims.

What is claimed is:

1. An article of manufacture comprising a processor and a non-transitory computer readable medium, vendor selection criterion encoded therein, and computer readable program code encoded therein, to select a vendor from which to purchase one or more resources, the computer readable program code comprising a series of computer readable program steps to effect:
receiving from each of a plurality of vendors:
a formatting of an on-line order form; and
one or more affiliate links for resources that the corresponding said vendor is offering for sale;
encoding the received said formatting and one or more said affiliate links in a non-transitory computer readable medium;
receiving a description of one or more desired said resources that a customer desires to purchase;
using the affiliate links and a predetermined vendor selection criterion to select one or more of the vendors from which to purchase one or more of the desired said resources;
populating, without any additional customer input, a corresponding said order form of a first selected said vendor using the received said formatting of the respective order form;
receiving, from the first selected said vendor, a purchase availability status of one or more of the desired said resources;
and
when the purchase availability status indicates that one or more of the desired said resources is available, completing, without any additional customer input, a purchase of one or more of the desired said resources from the first selected said vendor.

2. The article of manufacture of claim 1, wherein the computer readable program code further comprises a series of computer readable program steps to effect, when the availability status indicates that one or more of the desired said resources is unavailable, populating, without any additional customer input, a corresponding said order form of a second selected said vendor using the formatting of the respective order form.

3. The article of manufacture of claim 1, the computer readable program code further comprising a series of computer readable program steps to effect:
receiving payment information of a customer; and
encoding the payment information in the non-transitory computer readable medium, wherein the populating the corresponding said order form of the first selected said vendor further includes using the encoded said payment information.

4. The article of manufacture of claim 3, the computer readable program code further comprising a series of computer readable program steps to effect:
instructing a computing device of the customer to provide a security code associated with the payment information without any additional customer input; and
receiving the security code, wherein completing the purchase of one or more of the desired said resources includes providing the security code to the first selected said vendor.

5. The article of manufacture of claim 1, the computer readable program code further comprising a series of computer readable program steps to effect notifying the customer that one or more of the desired said resources will be purchased for a price below an estimated price.

6. The article of manufacture of claim 5, wherein the estimated price is an average price offered by the vendors selling one or more of the desired said resources.

7. The article of manufacture of claim 1, wherein the predetermined vendor selection criterion is a function of a price.

8. The article of manufacture of claim 1, wherein the predetermined vendor selection criterion is a function of a cost to purchase and have delivered to a known address one or more of the desired said resources.

9. The article of manufacture of claim 1, wherein using the vendor selection criterion includes:
determining, for each of the plurality of said vendors, an aggregate cost to purchase all of a plurality of the desired said resources from the respective said vendor, wherein the aggregate cost includes an individual price for each of the desired said resources less any savings due to purchasing all of the plurality of the desired said resources from the respective said vendor; and
selecting at least one said vendor with lower said aggregate costs than that of at least one other said vendor.

10. The article of manufacture of claim 1, the computer readable program code further comprising a series of computer readable program steps to effect creating, without any additional customer input, an account with the first selected said vendor, wherein the order form is populated under the account.

11. A method for selecting a vendor from which to purchase a plurality of resources desired by a customer, the method comprising:
receiving, at a host computing device, from each of a plurality of vendors:
a formatting of an on-line order form; and
one or more affiliate links for resources that the corresponding said vendor is offering for sale;
encoding, at the host computing device, the received said formatting and the one or more said affiliate links in a non-transitory computer readable medium;
receiving, at the host computing device from a customer computing device, customer information including:
payment information of a customer; and
a delivery address;
encoding, at the host computing device, the customer information in the non-transitory computer readable medium;
receiving, at the host computing device from the customer computing device, a vendor selection criterion and a description of a plurality of desired said resources that the customer desires to purchase and have delivered to the delivery address;
using, at the host computing device, the affiliate links and the vendor selection criterion to select a vendor from which to purchase all of the desired said resources, wherein the vendor is selected from among a plurality of said vendors each offering to sell and have delivered all of the desired said resources;
using the corresponding said formatting of the respective order form, at the host computing device and without any additional customer input, to populate a corresponding said order form of the selected said vendor for purchase and delivery of the all of the desired said resources to the delivery address;
receiving, at the host computing device from the selected said vendor, a purchase availability status of one or more of the desired said resources;
and
when the purchase availability status indicates that all of the desired said resources are available, completing, at the host computing device and without any additional customer input, a purchase of all of the desired said resources from the selected said vendor.

12. The method of claim 11, wherein:
selecting the vendor includes:
using the affiliate links, at the host computing device, to determine at least one said vendor offering to sell all of the desired said resources;
determining, at the host computing device, for each said vendor, an aggregate cost to purchase all of the desired said resources from the respective said vendor, wherein the aggregate cost includes an individual price for each of the desired said resources less any savings due to purchasing all of the desired said resources from the respective said vendor;
and
selecting, at the host computing device, the vendor with a lowest said aggregate cost;
and
further comprising creating, at the host computing device without any additional customer input, an account for the customer that is accessible via a website of the selected said vendor, wherein the order form is an on-line order form that is populated under the account.

13. The method of claim 11, further comprising, when the availability status indicates that one or more of the desired said resources is unavailable, populating, at the host computing device and without any additional customer input, a corresponding said order form of a second selected said vendor using the corresponding said formatting of the respective order form.

14. The method of claim 11, further comprising:
instructing, at the host computing device, the customer computing device to provide a security code associated with the payment information; and
receiving, at the host computing device from the customer computing device, the security code, wherein the populating the order form includes populating the order form with the security code.

16. A computer program product encoded in a non-transitory computer readable medium, the computer program product being useable with a computing device comprising a programmable processor to select a vendor from which to purchase a one or more resources desired by a customer, the computer program product comprising:
computer readable program code which causes a programmable processor to receive from each of a plurality of vendors:
a formatting of an on-line order form; and
one or more affiliate links for resources that the corresponding said vendor is offering for sale;
computer readable program code which causes a programmable processor to encode the received said formatting and one or more affiliate links in a non-transitory computer readable medium;
computer readable program code which causes a programmable processor to receive a description of one or more desired said resources that a customer desires to purchase;
computer readable program code which causes a programmable processor to use the affiliate links and a predetermined vendor selection criterion to select one or more said vendors from which to purchase one or more of the desired said resources;
computer readable program code which causes a programmable processor to populate, without any additional customer input, a corresponding said order form of a first selected said vendor using the formatting of the respective order form;
computer readable program code which causes a programmable processor to receive, from a first selected said vendor, a purchase availability status of one or more of the desired said resources;
and
computer readable program code which causes a programmable processor to, when the purchase availability status indicates that one or more of the desired said resources is available, complete, without any additional customer input, a purchase of one or more of the desired said resources from the first selected said vendor.

17. The computer program product of claim 16, further comprising:
computer readable program code which causes the programmable processor to query a computing device of the customer for payment information and a corresponding security code;
computer readable program code which causes the programmable processor to receive the payment information and the security code; and
computer readable program code which causes the programmable processor to populate, without any additional customer input or vendor input, the order form with the payment information and the security code.

18. The computer program product of claim 16, further comprising:
computer readable program code which causes the programmable processor to conduct a search on an Internet for at least one said vendor offering to sell all of the desired said resources;
computer readable program code which causes the programmable processor to determine, for each said vendor offering to sell all of the desired said resources, an aggregate cost to purchase all of the desired said resources from the respective said vendor, wherein the aggregate cost includes an individual price for each of the desired said resources less any savings due to purchasing all of the desired said resources from the respective said vendor;
computer readable program code which causes the programmable processor to select the vendor with a lowest said aggregate cost;
and
computer readable program code which causes the programmable processor to create, without any additional customer input, a vendor account for the customer, wherein the order form is an on-line order form that is populated under the vendor account.

19. The computer program product of claim 18, wherein the description of one or more of the desired said resources is a corresponding scanned Universal Product Code.

20. The computer program product of claim 16, further comprising computer readable program code which causes the programmable processor to, when the availability status indicates that one or more of the desired said resources is unavailable, populate, without any additional customer input, a corresponding said order form of a second selected said vendor using the corresponding said formatting of the respective order form.
